(19) United States
(12) Patent Application Publication
(10) Pub. No.: US 2025/0292010 A1
(43) Pub. Date: Sep. 18, 2025

(54) Systems and Methods for Linguistically-Selective Web Form Generation

(71) Applicant: Veeva Systems Inc., Pleasanton, CA (US)

(72) Inventors: Florian Emmanuel Bernard Gilbert Letourneux, Rennes (FR); Marius K. Mortensen, Burlington (CA); Justine Tanya dela Cruz Lo, Dublin, CA (US); Jean-Christophe Meriaux, Concord, CA (US); Nathan Joseph Janken, Dublin, CA (US); Zhanye Tong, San Ramon, CA (US)

(73) Assignee: Veeva Systems Inc., Pleasanton, CA (US)

(21) Appl. No.: 18/606,049

(22) Filed: Mar. 15, 2024

(51) Int. Cl. G06F 40/186; G06F 16/955; G06F 40/134; G06F 40/58

(52) U.S. Cl. CPC G06F 40/186; G06F 16/9558; G06F 16/9566; G06F 40/134; G06F 40/58

(57) ABSTRACT

A method for generating a web form. The method include receiving a source file and determining case data based on the source file. The method further includes generating a case dataset including the case data. The method further includes selecting a rule including a rule criteria and determining the case data of the case dataset fulfills the rule criteria. The method further includes selecting a web form template. The method further includes generating the web form including at least a portion of the case data of the case dataset. The method further includes generating a link associated with the web form. The method further includes outputting the link to the destination address of the rule. The method further includes receiving a request to access the web form, and outputting the web form based on the request. The method further includes receiving follow-up case data.

### TECHNICAL FIELD

The present disclosure relates to systems and methods for linguistically-selective web form generation.

### BACKGROUND

Researchers, scientists, industry players, academics, government regulators, and other stakeholders are increasingly in need of efficient and simple ways to generate web forms through linguistically-selective modes.

### SUMMARY

One embodiment relates to a method for generating a web form. The method include receiving a source file. The method further includes determining case data based on the source file. The method further includes generating the case dataset including the case data. The method further includes selecting a rule including a rule criteria and a destination address from a first repository of the provider computing system. The method further includes determining the case data of the case dataset fulfills the rule criteria. The method further includes selecting a web form template from a second repository of the provider computing system. The method further includes generating the web form based on the web form template and the case dataset. The web form includes at least a portion of the case data of the case dataset. The method further includes generating a link associated with the web form. The method further includes outputting the link to the destination address of the rule. The method further includes receiving a request to access the web form, and outputting the web form based on the request. The method further includes receiving follow-up case data.

In additional embodiments, the method further includes outputting the case dataset including the case data as an E2B XML file.

In additional embodiments, the rule includes a rule trigger, and the method further includes modifying, in response to outputting the case dataset, a state of the case dataset from a first stage to a second stage, and selecting, in response to the rule trigger of the rule being met based on the state of the case dataset being the second stage, the rule from the first repository of the provider computing system.

In additional embodiments, the method further includes modifying the case dataset to include the follow-up case data, and outputting, by the provider computing system and after outputting the case dataset, the modified case dataset including the follow-up case data as an E2B XML file.

In additional embodiments, the case dataset includes a version of the case dataset. Further, in additional embodiments, modifying the case dataset includes generating a new version of the case dataset, and modifying the case dataset to include the follow-up case data and the new version.

In additional embodiments, the method further includes receiving one or more mapping preferences, and modifying the case dataset to include the follow-up case data based on the one or more mapping preferences.

In additional embodiments the case data includes reporter data, and the web form template includes first text data in a first language and second text data in a second language. Further, in additional embodiments, the method further includes determining a language of the reporter based on the reporter data, and generating, in response to the language of the reporter being the first language, the web form including the first text data in the first language based on the web form template.

In additional embodiments, the case data includes reporter data, and the web form template includes text data in a first language. Further, in additional embodiments, the method further includes determining a language of the reporter based on the reporter data; translating, in response to the language of the reporter being a second language, the text data of the web form template from the first language to the second language; and generating the web form including the translated text data.

In additional embodiments, the link is a public access link. In additional embodiments, the method further includes generating a token; generating, the public access link including a uniform resource locator (URL). The URL includes the token. In additional embodiments, the method further includes generating a correspondence including the public access link; outputting the correspondence including the public access link to the destination address; receiving a request to access the web form including the token from a client computing device; validating the client computing device based on the token; and outputting, in response to validating the client computing device, the web form to the validated client computing device.

In additional embodiments, the case data includes a patient's initials, and the web form includes the patient's initials of the case data.

In additional embodiments, the rule is a first rule, and the rule criteria is a first rule criteria. Further, in additional embodiments, the method further includes selecting a second rule including a second rule criteria from the first repository of the provider computing system; determining the case data of the case dataset does not fulfill the second rule criteria; and selecting, in response to determining the case data of the case dataset does not fulfill the second rule criteria, the first rule including the first rule criteria and the destination address from the first repository of the provider computing system.

In additional embodiments, the web form includes one or more text sections. In additional embodiments, the web form is output to a client computing device for display on a user interface including the one or more text sections. In additional embodiments, the follow-up case data is received from the client computing device via the one or more text sections of the user interface.

Another embodiment relates to a method for generating a web form. The method includes selecting, by a provider computing system, a case dataset including case data from a first repository of the provider computing system. The method further includes selecting a rule including a rule criteria from a second repository of the provider computing system. The method further includes determining the case data of the case dataset fulfills the rule criteria. The method further includes selecting a web form template from a third repository of the provider computing system. The web form template identifies a first section to include in the web form. The method further includes receiving a request identifying a second section to include in the web form. The method further includes generating the web form including the first section and the second section based on the web form template and the request. The method further includes generating a link associated with the web form. The method further includes determining a destination address. The method further includes outputting the link to the destination address. The method further includes receiving follow-up case data. The method further includes modifying the case dataset to include the follow-up case data. The method further includes storing the modified case dataset in the first repository.

In additional embodiments, the case data includes reporter data, and first section of the web form template and the second section of the request each include text data in a first language. In additional embodiments, the method further includes determining a language of the reporter based on the reporter data; translating, in response to the language of the reporter being a second language, the text data of the first section and the second section from the first language to the second language; and generating the web form including the first section including the text data of the first section in the second language and the second section including the text data of the second section in the second language.

In additional embodiments, the method further includes receiving, by a provider computing system, a source file; determining the case data based on the source file; generating the case dataset including the case data; and storing the case dataset in the first repository.

In additional embodiments, the case data includes reporter data including a reporter address, and the destination address is determined based on the reporter address.

In additional embodiments, the link is a public access link. In additional embodiments, the method further includes generating a token; generating, the public access link including a uniform resource locator (URL). The URL includes the token. In additional embodiments, the method further includes generating a correspondence including the public access link; outputting the correspondence including the public access link to the destination address; receiving a request to access the web form including the token from a client computing device; validating the client computing device based on the token; and outputting, in response to validating the client computing device, the web form to the validated client computing device.

In additional embodiments, the case data includes a patient's initials, and the first section of the web form includes the patient's initials of the case data.

In additional embodiments, the rule is a first rule, and the rule criteria is a first rule criteria. In additional embodiments, the method further includes selecting a second rule including a second rule criteria from the second repository of the provider computing system; determining the case data of the case dataset does not fulfill the second rule criteria; and selecting, in response to determining the case data of the case dataset does not fulfill the second rule criteria, the first rule including the first rule criteria and the destination address from the second repository of the provider computing system.

Another embodiment relates to a method for generating a web form. The method includes selecting, by a provider computing system, a case dataset including case data from a first repository of the provider computing system. The case data includes reporter data. The method further includes selecting a rule including a rule criteria from a second repository of the provider computing system. The method further includes determining the case data of the case dataset fulfills the rule criteria. The method further includes selecting a first web form template including text data in a first language from a third repository of the provider computing system. The method further includes selecting a second web form template including text data in a second language from the third repository of the provider computing system. The method further includes determining a language of the reporter based on the reporter data. The method further includes selecting, in response to the language of the reporter being the first language, the first web form template. The method further includes generating the web form based on the selected first web form template. The method further includes generating a link associated with the web form. The method further includes determining a destination address. The method further includes outputting the link to the destination address. The method further includes receiving follow-up case data. The method further includes modifying the case dataset to include the follow-up case data. The method further includes storing the modified case dataset in the first repository.

In additional embodiments, the link is a public access link. In additional embodiments, the method further includes generating a token; generating, the public access link including a uniform resource locator (URL). The URL includes the token. In additional embodiments, the method further includes generating a correspondence including the public access link; outputting the correspondence including the public access link to the destination address; receiving a request to access the web form including the token from a client computing device; validating the client computing device based on the token; and outputting, in response to validating the client computing device, the web form to the validated client computing device.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 may be a component diagram of a case generation and processing system, according to an example embodiment.

FIG. 2 may be a flow diagram of a method for storing a rule and one or more web form templates, according to an example embodiment.

FIG. 3 may be a flow diagram of a method for generating a case dataset, according to an example embodiment.

FIGS. 4A-4B may be a flow diagram of a method for generating a web form and receiving follow-up case data via the web form, according to an example embodiment.

FIG. 5 may be an illustration of some aspects of a user interface generated by the case generation and processing system of FIG. 1 to manage one or more rules, according to an example embodiment.

FIG. 6 may be an illustration of some aspects of a user interface generated by the case generation and processing system of FIG. 1 to manage a specific rule, according to an example embodiment.

FIG. 7 may be an illustration of some aspects of a user interface generated by the case generation and processing system of FIG. 1 to manage and process a case dataset, according to an example embodiment.

FIGS. 8A-8B may be illustrations of some aspects of a user interface generated by the case generation and processing system of FIG. 1 to output a correspondence and manage follow-up case data received in response to the correspondence, according to an example embodiment.

FIG. 9 may be an illustration of some aspects of a user interface generated by the case generation and processing system of FIG. 1 to display a correspondence, according to an example embodiment.

FIGS. 10A-10B may be illustrations of some aspects of a user interface generated by the case generation and processing system of FIG. 1 to display a web form and receive follow-up case data via the web form, according to an example embodiment.

### DETAILED DESCRIPTION

Referring generally to the figures, systems and methods for linguistically-selective web form generation are disclosed. The systems and methods described herein provide for the generation and processing of a case dataset and the automatic generation of a follow-up questionnaire (i.e., a web form) in a linguistically-selective way, and thereby help and improve the pharmacovigilance industry by more accurately and efficiently, capturing, and collecting follow-up case data (e.g., case data that is collected after the initial receipt of an adverse event report). For example, by utilizing a rule including rule criteria to determine when to generate a follow-up, the present systems can speed up follow-up questionnaire generation and distribution, thereby shortening the time it takes for the questionnaires to be processed as well as follow-up or updated-version case datasets to be generated and reported to the relevant health authorities. For instance, because the present systems and methods select a rule including rule criteria and then generate a web form, in response to the rule criteria being met, the present systems and methods can automatically generate and distribute the web form, thereby not requiring manual correction and checks. Further, because the systems and methods described herein remove the time-consuming and laborious manual processing of follow-up submissions, the present systems use less computing power and memory than typical systems by not communicating with the client computing device to determine the rule is fulfilled, which also allows for quicker and more efficient follow-up case dataset generation and reporting.

Additionally, by providing for linguistically-selective generation of the web form, the present systems and methods provide for an improvement to case dataset follow-up web form generation and case dataset processing systems. For instance, in typical case dataset follow-up generation, a web form may be generated in a single language (e.g., English) which is then provided to reporter's who speak different languages thereby resulting in low conversion or response rates, and less accurate responses. In comparison, because the web form is generated to include text data in the language of the recipient (e.g., the reporter), the present systems and methods provide for improved engagement and more accurate follow-up case data. For instance, because the web form is generated to include text data in the language of the recipient, the present systems and methods tailor the file's language to the recipient resulting in the recipient being more likely to understand and engage with the web form, leading to better user experience and higher conversion or response rates, as well as requiring less processing power to follow-up on the web form multiple times. Likewise, because the web form is generated to include text data in the language of the recipient (e.g., the reporter), the present systems and methods result in more accurate responses (e.g., follow-up case data). For instance, by knowing and utilizing the language the recipient prefers, the present systems and methods provide for tailored questions and better context. This provides for improved and more accurate responses that are more aligned with the intended meaning of the follow-up questions.

By prepopulating the web form with case data and allowing for customizable questions, the present systems and methods further provide for an improvement to case dataset follow-up web form generation and case dataset processing systems. For instance, because the present systems and methods utilize prefilled or prepopulated questions, where the answer is already known, the present systems and methods provides for improved efficiency and data collection through dynamic content generation and reduced data entry errors. For instance, the present systems and methods provide for a tailored experience that adapts to previously received data, thereby only asking relevant follow-up questions keeping the user engaged and more likely to respond to the other questions of the web form, which results in higher response rates as well as a greater amount of follow-up case data. Likewise, by populating the web form with case data, the present systems and methods provide for reduced data entry errors. For example, prepopulating the web form with case data eliminates the risk of typos, inconsistencies, and missing data due to manual entry errors, thereby resulting in less time, memory, and processing power spent correcting or re-submitting forms, improving data quality and workflow efficiency.

As used herein, the term “event,” “medical event,” or “adverse event” can include any untoward medical occurrence which happens to either a patient or a subject in a clinical investigation or during regular use of a medical product that has been given to that person. For example, the “event,” “medical event,” or “adverse event” may encompass any signs which are unfavorable and unexpected for the patient or subject, including any abnormal laboratory findings such as a high blood pressure, a rapid heart rate, etc. The “event,” “medical event,” or “adverse event” could be symptoms, or a disease temporally associated with the use of a medical product and does not have to have been previously associated with that product. The term “event,” “medical event,” or “adverse event” can further encompass adverse reactions and serious adverse events such as death, life-threatening adverse experiences, inpatient hospitalization, congenital birth defects, disabilities, etc. Further, each “event,” “medical event,” or “adverse event” may be defined by the Medical Dictionary for Regulatory Activities (MedDRA) (or other medical code dictionaries) and associated with a specific MedDRA code. Moreover, “event information” “medical event information” “adverse event information” “event data” “medical event data” or “adverse event data” can include information associated with the event such as the date of onset of the event, the date of cessation of the event, the type of event, the dictionary (i.e., digital dictionary, medical dictionary, digital medical dictionary, etc.) or medical term (e.g., MedDRA term), the dictionary or medical code (e.g., MedDRA code), event comments, the outcome of the event, the location of the event (e.g., country where the event occurred), the event duration, patient data for a patient who endured or to which the event occurred, medical products (and associated medical product data) or substances that the patient consumed and/or dosages for the consumed medical products, the event rank, event contacts, the event type, and any associated event documents.

As used herein, the term “case” or “case dataset” can include an Individual Case Safety Report (ICSR) as defined by the standard ISO/HL7 27953 of the International Standards Organization (ISO) as well as any past or future standards governing ICSRs of the ISO, the World Health Organization (WHO), the Food and Drug Administration (FDA), the European Medicines Agency (EMA), or other national health agencies governing ICSRs. Moreover, “case information” “case data” or “case dataset” can include information associated with or included in the case such as adverse event data, case contact or reporter data, a case identifier (e.g., case worldwide ID (WWID), case number, etc.), case priority data, case seriousness data, case documents, medical product data (e.g., substances in the medical product, medical product registrations, medical product dosages, medical product name, etc.) patient data, and other data associated with a case as defined by the standard ISO/HL7 27953 as well as any past or future standards governing ICSRs of the ISO, the WHO, the FDA, the EMA, or other national health agencies governing ICSRs.

As used herein, the term “web form” can include a world-wide web form or a world-wide web page which includes multiple interactive elements that allow a user to enter and submit information. For instance, the “web form” can include one or more digital pharmacovigilance follow-up questionnaires (FUQ), which are a standardized tool used to gather additional information about a suspected adverse reaction (SAR) that has been reported. It is essentially a questionnaire sent to the healthcare professional who reported the SAR, or to the patient themselves, to collect more details about the event. In general, FUQs can be general or specific. General FUQs are used to collect information about any SAR, while specific FUQs are tailored to a particular type of SAR or safety concern. In one example, the EMA provides guidance, EMA/PRAC/490455/2023, to define some of the specific uses of the FUQ.

As used herein the terms “data” and “information” are interchangeable such that one may be substituted for the other and vice versa.

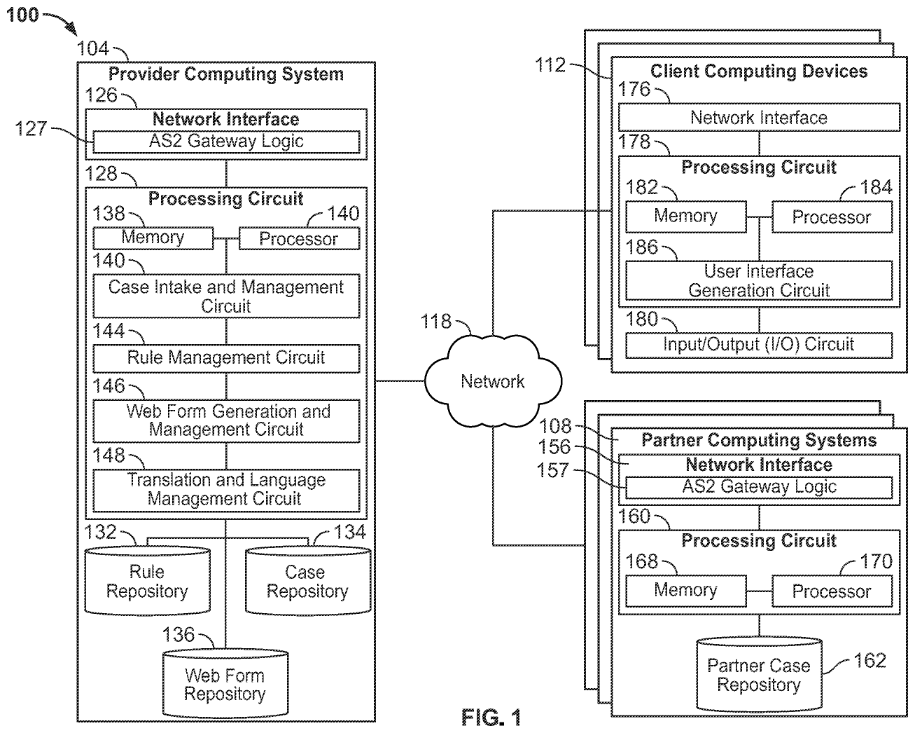

Referring now to FIG. 1, a system 100 for generating and processing case datasets and generating a web form, in response to the processing of the case datasets, is shown, according to an example embodiment. The system 100 includes a provider computing system 104, multiple partner computing systems 108, and multiple client computing devices 112 connected by a secure network (e.g., a network 118).

The network 118 communicably and operably couples the provider computing system 104, the partner computing devices 108, and the client computing devices 112 such that communicable and operable computing may be provided between the provider computing system 104, the partner computing devices 108, and the client computing devices 112 over the network 118. In various embodiments, the network 118 includes any combination of a local area network (LAN), an intranet, the Internet, or any other suitable communications network, directly or through another interface.

The provider computing system 104 may be operated and managed by a provider (e.g., a software as a service (SaaS) provider, a cloud services provider, a software provider, a service provider, etc.) and may be a computer system including one or more servers (e.g., a cloud computing server) each including one or more processing circuits. In some embodiments, the provider computing system 104 may act as a host and provide an application (e.g., a web-based application, a mobile application, etc.) to the client computing devices 112 over the network 118 in response to authenticating the respective computing device. For example, the provider computing system 104 may receive authentication data (e.g., a username and corresponding password, a limited-use key, a two-factor authentication code or key, etc.) from one of the client computing devices 112. The provider computing system 104 may then authenticate the client computing device 112 based on the authentication data and provide an application to the client computing device 112 over the network 118. In some examples, the provider computing system 104 may be a multi-tenant system where various elements of hardware and software may be shared by one or more customers. In a multi-tenant system, a user is typically associated with a particular customer. In one example, a user (e.g., of the client computing device 112) could be an employee of one of a number of (pharmaceutical) companies which are tenants, or customers, of the provider computing system 104.

In some embodiments, the provider computing system 104 may run on a cloud computing platform. Users can access content on the cloud independently by using a virtual machine image or purchasing access to a service maintained by a cloud repository provider.

In some embodiments, the provider computing system 104 may be provided as Software as a Service (“SaaS”) to allow users to access the provider computing system 104 with a thin client.

As shown, the provider computing system 104 may include a network interface 126, a processing circuit 128, a first repository 132 (also referred to as a rule repository 132), a second repository 134 (also referred to as a case repository 134), and a third repository 136 (also referred to as a web form repository 136). In some embodiments, the provider computing system 104 may include an input/output circuit (e.g., similar to (e.g., the same as) an input/output circuit 180 as will described further herein).

The network interface 126 is structured to establish connections with the partner computing devices 108 and the client computing devices 112 by way of the network 118. The network interface 126 includes program logic (e.g., AS2 Gateway Logic 127) and/or hardware-based components that connect the provider computing system 104 to the network 118. For example, the network interface 126 may include any combination of a wireless network transceiver (e.g., a cellular modem, a broadband modem, a Bluetooth transceiver, a Wi-Fi transceiver, a Li-Fi transceiver, etc.) and/or a wired network transceiver (e.g., an Ethernet transceiver). In some embodiments, the network interface 126 includes the hardware and machine-readable media structured to support communication over multiple channels of data communication (e.g., wireless, Bluetooth, near-field communication (NFC). In some embodiments, the network interface 126 includes cryptography logic and capabilities to establish a secure communications session.

The AS2 gateway logic 127 includes programmable instructions that facilitate communication (transmission and receipt) using the Applicability Statement 2 (AS2) communication protocol (as specified in Request for Comment (RFC) 4130) over the network 118 via the network interface circuit 126. For example, using the AS2 gateway logic 127, the network interface 126 may transmit or receive files (e.g., the source file, a case, etc.) or other data to the partner computing systems 108 or client computing devices 112 using the AS2 Gateway protocol. In other embodiments, the AS2 gateway logic 127 may transmit or receives files using the most updated Applicability Statement communication protocol (e.g., AS3, etc.).

The processing circuit 128, as shown, comprises a memory 138, a processor 140, a case intake and management circuit 140, a follow-up rule management circuit 144, a web form generation and management circuit 146, and a translation and language management circuit 148. The memory 138 includes one or more memory devices (e.g., RAM, NVRAM, ROM, flash memory, hard disk storage, etc.) that store data and/or computer code for facilitating the various processes described herein. That is, in operation and use, the memory 138 stores at least portions of instructions and data for execution by the processor 140 to control the processing circuit 128. The memory 138 may be or include tangible, non-transient volatile memory and/or non-volatile memory. The processor 140 may be implemented as a general-purpose processor, an application specific integrated circuit (ASIC), one or more field programmable gate array (FPGAs), a digital signal processor (DSP), a group of processing components or other suitable electronic processing components.

As described herein, the case intake and management circuit 140 is structured or configured to receive, generate, store, and manage case datasets. For instance, the case intake and management circuit 140 may be configured or structured to periodically receive or retrieve a source file including adverse event data associated with an adverse event from a trusted source (e.g., one of the partner case repositories 162). In some embodiments, the case intake and management circuit 140 may then match the adverse event data with medical product data of a medical product repository (not shown), generate a case dataset including case data, and store the case dataset within the case repository 134. In one example, the case intake and management circuit 140 may be an instance of Vault Safety®. In some embodiments, the provider computing system 104 may include multiple case intake and management circuits 140 (e.g., one for each customer, one for each user, etc.). In some embodiments, when generating the case dataset, the case intake and management circuit 140 may further search the case repository 134 for case datasets which may be a duplicate of the newly generated case. In other embodiments, the case intake and management circuit 140 may output (via the network interface circuit 126) one or more of the case datasets as a specific file type (e.g., E2B (R3) XML file, as a Council for International Organizations of Medical Sciences (CIOMS) II PDF file, 3500A PDF file, etc.) to one or more of the partner computing systems 108 or the client computing devices 112.

Additionally, the case intake and management circuit 140 may be configured or structured to receive follow-up case data (also referred to as additional case data) (e.g., case data which was received via a follow-up communication) and add the additional case data to a specific case dataset, or generate a new version of the case dataset and add the follow-up case data to the new version of the case dataset. For instance, the case intake and management circuit 140 may receive follow-up case data indicating a new adverse event was experienced by a patient. In response, case intake and management circuit 140 may generate a new version of the case dataset (e.g., from version 1.0 to version 2.0) and add the new adverse event to the case dataset (in addition to the previous adverse event(s). Further, the case intake and management circuit 140 may retrieve cases from the case repository, in response to receiving a request including case criteria (e.g., a medical product of the case, a date of the case, a state or stage of the case (e.g., open, closed, submitted, pending review), a country in which the case took place, etc.) from one of the user computing devices 108.

As described herein, the rule management circuit 144 is structured or configured to receive a specific rule (also referred to as an event) from one of the client computing devices 112 and store the rule in the rule repository 132. Rules or events will be described further herein, but may include multiple rule criteria, a destination address, a rank or order, a rule trigger, a total number of attempts, and a timeframe or number of days between attempts. The rule criteria may include specific data fields that indicate the rule is fulfilled. For instance, the rule criteria may include a specific adverse event of a case dataset (e.g., a specific MedDRA code and term), a specific seriousness of a case dataset (e.g., serious-results in death, serious-hospitalization, non-serious, etc.), a specific medical product (e.g., a specific national drug code (NDC), a specific substance, a specific combination of substances, etc.), a specific reporter language (e.g., Chinese, English, etc.), and the like. Similarly, the rule trigger may be an event or change in the data that indicates the provider computing system 104 is to determine if the rule is fulfilled. For instance, the rule trigger may include a specific state or stage of a case dataset (e.g., completed, submitted, new, data entry required, quality-check required, etc.), a specific period of time (e.g., every minute, every five minutes, once a year on January 1, etc.)), and/or a specific date/time (e.g., Jan. 1, 2021). In one example, in response to the case dataset entering or reaching a specific stage (e.g., the state of the case dataset being modified from a first stage (e.g., data entry) to a second stage (e.g., complete)), the provider computing system 104 may determine the rule trigger is met and determine if the case data fulfills the rule criteria of the rule. Likewise, the destination address will be described further herein, but may include an electronic address (e.g., an email address, an internet protocol (IP) address, a file transfer protocol (FTP) address, a AS2 address, and the like) to which a web form is to be provided, in response to the rule criteria being met.

Additionally, the rule management circuit 144 may be structured or configured to periodically (e.g., every minute, every half-minute, every time a case dataset changes stages) determine if any of the rules are fulfilled (e.g., based on the rule trigger). For instance, in response to a case dataset being changed to the completed or “approved” stage, the rule management circuit 144 may determine if the case dataset meets or fulfills any of the rules of the rule repository 132. For instance, the rule management circuit 144 may select each rule, in the order they are listed (e.g., rule including the order 1, followed by the rule including the order 2, and so on). Then, in response to determining the rule criteria of the rule matches the case dataset, the rule management circuit 144 may execute the rule, or provide an indication to the web form generation and management circuit 146 to execute the rule, as will be described further herein.

The web form generation and management circuit 146 is structured or configured to receive a web form template from one or more of the client computing devices 112, and then store the web form template in the web form repository 136. For instance, the web form generation and management circuit 146 may receive a web form template for a questionnaire that is provided to reporters, in response to reporting a non-serious adverse event. In another example, the web form generation and management circuit 146 may receive a first web form template for a first questionnaire that is provided to reporters who speak or utilize a first language, in response to a specific adverse event (e.g., hand cramping) and medical product (e.g., drug X). Further, the web form generation and management circuit 146 may receive a second web form template for the questionnaire that is provided to reporters who speak or utilize a second language, in response to a specific adverse event and medical product.

Additionally, in response to a specific rule being met (e.g., a case dataset matching the rule criteria of the rule), the web form generation and management circuit 146 may receive an indication of such, select a specific web form template from the web form repository 136, and generate a web form based on the web form template and the case dataset. For instance, the web form generation and management circuit 146 may generate the web form based on (e.g., using or copying the web form template) and populate the web form with case data of the case dataset (e.g., reporter initials, date information, case identifier(s), etc.). In some embodiments, the web form generation and management circuit 146 may further output or transmit the web form, in response to receiving a request to do so, as will be described further herein.

The translation and language management circuit 148 is structured or configured to translate specific words, terms, and fields that are to be provided to the client computing device 112 for display based on a display language of the user (e.g., a display language that is received by the provider computing system 104 from the client computing device 112) or the follow-up case data, as will be described further herein. For example, the translation and language management circuit 148 may translate text fields or labels of the web form based on a specific language of the reporter.

Still referring to FIG. 1, the rule repository 132 may be repository (e.g., a database) that is structured or configured to receive, store, and manage rules or events of users or customers. In this regard, the rule repository 132 may receive, store, and manage rules including rule criteria, destination address(es), associated web form templates, timeframes between attempts, a total number of attempts, and the like. For example, a customer may provide or generate a rule that includes a rule criteria of a first medical product, a first adverse event, a specific destination address (e.g., an email address), a specific web form template, and a specific case state or stage (e.g., completed or submitted). Accordingly, the rule repository 132 may receive the rule from one of the client computing devices 112 and store it therein. Then, in response to a state of the case entering the specific case stage, the rule management circuit 144 may select the rule from the rule repository 132 and determine if each of the rule criteria is met. Accordingly, the rule repository 132 can be structured according to various database types, such as, relational, hierarchical, network, flat, point-in time, and/or object relational. Further, the rule repository 132 may include a plurality of nonvolatile/non-transitory storage media such as solid-state storage media, hard disk storage media, virtual storage media, cloud-based storage drives, storage servers, and/or the like.

Likewise, the case repository 134 may be repository (e.g., a database) that is structured or configured to receive, store, and manage case datasets and their respective data (e.g., case data, adverse event data, etc.). For example, the case repository 134 may receive case datasets and related case objects and store the case datasets therein. Then, in response to receiving a query or a request for one or more case datasets (e.g., a query for all cases that include a specific substance), the case repository 134 may provide and/or return the case datasets stored therein that match the query or request. For example, the case repository 134 may receive a query from the case intake and management circuit 140 for all cases that include a specific criteria (e.g., a specific medical product, a specific country of origin, a specific date range). In response, the case repository 134 may determine each case dataset that includes the specific criteria stored therein and return each case dataset. In some embodiments, as will be described further herein, the case repository 134 may receive, store, and manage multiple versions for each case dataset. For instance, in response to receiving follow-up case data, the case intake and management circuit 140 may select the corresponding case dataset (e.g., version 1.0), version the case dataset (e.g., to version 1.5), add the follow-up case data to the case dataset, and store the new version of the case dataset in the case repository 134. In this regard, the case repository 134 may store the original version of the case dataset and the versioned or updated version of the case dataset.

Further, the case repository 134 can be structured according to various database types, such as, relational, hierarchical, network, flat, point-in time, and/or object relational. In some embodiments, the case repository 134 includes a plurality of nonvolatile/non-transitory storage media such as solid-state storage media, hard disk storage media, virtual storage media, cloud-based storage drives, storage servers, and/or the like.

The web form repository 136 may be a repository (e.g., a database) that is structured or configured to receive, store, and manage web forms and web form templates. In this regard, the web form repository 136 may receive, store, and manage web forms and web form templates including text sections, an ad-hoc question option or preference, an ad-hoc section option or preference, a subject field, text fields, text labels, and the like. For example, a customer may provide or generate a web form template that includes multiple text sections (e.g., four text sections) with each section including multiple text fields or labels. The web form template may further include an email subject field and an email text field. Accordingly, the web form repository 136 may receive the web form template from one of the client computing devices 112 and store it therein. Then, in response to an associated or corresponding rule being met, the web form generation and management circuit 146 may select the web form template from the web form repository 136 and generate a web form based on the web form template. The web form generation and management circuit 146 may then store the web form in the web form repository 136. Accordingly, the web form repository 136 can be structured according to various database types, such as, relational, hierarchical, network, flat, point-in time, and/or object relational. Further, the web form repository 136 may include a plurality of nonvolatile/non-transitory storage media such as solid-state storage media, hard disk storage media, virtual storage media, cloud-based storage drives, storage servers, and/or the like.

While not shown, in some embodiments, the provider computing system 104 may include a separate repository for each data type described herein. For instance, the provider computing system 104 may include the case repository 134, the rule repository 132, the web form repository 136, a reporter repository (not shown), a medical product repository (not shown), an adverse event repository or dictionary, a public access link (PAL) repository, a study repository (not shown), and the like.

Still referring to FIG. 1, the partner computing systems 108 may be managed by third-party partners (e.g., the FDA, the EHA, Health Canada, partner company 1, partner company 2, partner computing system xyz, etc.) and can be or include a computing device or system configured to communicate with the provider computing system 104 over the network 118. For instance, the partner computing systems 108 can be a server computer system, a gateway computing system, a laptop computer a desktop computer, and any other network-connected device that can communicate over the network 118. For example, one of the partner computing systems 108 may be the Electronics Submission Gateway (ESG) of the FDA through which one or more E2B XML files may be received from and/or provided to. In another example, one of the partner computing systems 108 may be a laptop computer operated by an employee of a partner company.

In operation, the partner computing systems 108 may communicate with the provider computing system 104 or the client computing device 112 to send and/or receive one or more electronic communications (e.g., case datasets, source files, etc.). For instance, a customer (e.g., pharma company 123) may submit case datasets to the FDA over the ESG of the FDA. Accordingly, the provider computing system 104 may provide case datasets to the first partner computing system associated with the FDA. For instance, the provider computing system 104 may generate an outbound transmission including one or more case datasets. Then, the provider computing system 104 may output the outbound transmission to the first partner computing system 108.

As shown, each partner computing system 108 includes a network interface 156, a processing circuit 160, and a partner case repository 162. In some embodiments, each partner computing system 108 further includes a key repository (not shown) for storing AS2 keys and certificates.

The network interface 156 is structured to establish connections with the provider computing system 104 and/or the client computing device 112 by way of the network 118. The network interface 156 includes program logic (e.g., AS2 Gateway logic 157) and/or hardware-based components that connect each partner computing system 108 to the network 118. For example, the network interface 156 may include any combination of a wireless network transceiver (e.g., a cellular modem, a broadband modem, a Bluetooth transceiver, a Wi-Fi transceiver, a Li-Fi transceiver, etc.) and/or a wired network transceiver (e.g., an Ethernet transceiver). In some embodiments, the network interface 156 includes the hardware and machine-readable media structured to support communication over multiple channels of data communication (e.g., wireless, Bluetooth, near-field communication (NFC). In some embodiments, the network interface 156 includes cryptography logic and capabilities to establish a secure communications session.

The AS2 gateway logic 157 includes programmable instructions that facilitate communication (transmission and receipt) using the Applicability Statement 2 (AS2) communication protocol (as specified in Request for Comment (RFC) 4130) over the network 118 via the network interface circuit 156. For example, using the AS2 gateway logic 157, the network interface 156 may transmit or receive files (e.g., the source file, a case, etc.) or other data to the provider computing system 104 or client computing devices 112 using the AS2 Gateway protocol. In other embodiments, the AS2 gateway logic 157 may transmit or receives files using the most updated Applicability Statement communication protocol (e.g., AS3, etc.).

The processing circuit 160, as shown, comprises a memory 168 and processor 170. The memory 168 includes one or more memory devices (e.g., RAM, NVRAM, ROM, flash memory, hard disk storage, etc.) that store data and/or computer code for facilitating the various processes described herein. That is, in operation and use, the memory 168 stores at least portions of instructions and data for execution by the processor 170 to control the processing circuit 160. The memory 168 may be or include tangible, non-transient volatile memory and/or non-volatile memory. The processor 170 may be implemented as a general-purpose processor, an application specific integrated circuit (ASIC), one or more field programmable gate array (FPGAs), a digital signal processor (DSP), a group of processing components or other suitable electronic processing components.

The partner case repository 162 may be similar or the same as the case repository 134 and is a repository (e.g., a database, cloud storage, etc.) that is structured or configured to receive, store, and manage case datasets associated with adverse events. For example, one of the partner computing systems 108 may receive a case dataset from the provider computing system 104 and store case dataset in the partner case repository 162. Further, the partner case repository 162 can be structured according to various database types, such as relational, hierarchical, network, flat, point-in time, and/or object relational. In some embodiments, the partner case repository 162 includes a plurality of nonvolatile/non-transitory storage media such as solid-state storage media, hard disk storage media, virtual storage media, cloud-based storage drives, storage servers, and/or the like.

Still referring to FIG. 1, the client computing devices 112 can each be any type of computing device or computing system. For instance, each client computing device 112 can be one or more of a mobile phone, a tablet computer, a laptop computer, a smart watch, a server computer system, or any other internet-connected device. In this regard, each client computing device 112 may be an access-controlled or privileged access device. For instance, a client computing device 112 which provides a specific set of login credentials (e.g., admin credentials) may have additional privileges and thereby access to additional data and features as compared to another client computing device 112 which provides another set of login credentials (e.g., general case processor credentials). In operation, the client computing devices 112 may communicate and interface with the provider computing system 104 via the network 118 to provide and setup one or more rules including rule criteria, web form template(s), and destination addresses to be used in processing the rule. As shown, each client computing device 112 may include a network interface 176, a processing circuit 178, and the input/output (I/O) circuit 180.

The network interface is 176 structured to establish connections with the provider computing system 104 by way of the network 118. The network interface 176 includes program logic and/or hardware-based components that connect the client computing device 112 to the network 118. For example, the network interface 176 may include any combination of a wireless network transceiver (e.g., a cellular modem, a broadband modem, a Bluetooth transceiver, a Wi-Fi transceiver, a Li-Fi transceiver, etc.) and/or a wired network transceiver (e.g., an Ethernet transceiver). In some embodiments, the network interface 176 includes the hardware and machine-readable media structured to support communication over multiple channels of data communication (e.g., wireless, Bluetooth, near-field communication (NFC). In some embodiments, the network interface 176 includes cryptography logic and capabilities to establish a secure communications session.

The processing circuit 178, as shown, comprises a memory 182, a processor 184, and a user interface generation or rendering circuit 186. The memory 182 includes one or more memory devices (e.g., RAM, NVRAM, ROM, flash memory, hard disk storage, etc.) that store data and/or computer code for facilitating the various processes described herein. That is, in operation and use, the memory 182 stores at least portions of instructions and data for execution by the processor 184 to control the processing circuit 178. The memory 182 may be or include tangible, non-transient volatile memory and/or non-volatile memory. The processor 184 may be implemented as a general-purpose processor, an application specific integrated circuit (ASIC), one or more field programmable gate array (FPGAs), a digital signal processor (DSP), a group of processing components or other suitable electronic processing components.

The user interface rendering circuit 186 may be configured to receive a user interface (a web interface in an HTML file and related files, a downloaded graphical user interface, etc.) from the provider computing system 104 and render the user interface on the client computing device 112 via the I/O circuit 180. In this way, the provider computing system 104 may generate one or more user interfaces and provide the one or more user interfaces to the user interface generation circuit 186 to be rendered on the client computing device 112 (e.g., on a display of the I/O circuit 180 of the client computing device 112). For instance, the provider computing system 104 may generate the web form, at step 420. Then, in response to receiving the request to access the web form, the provider computing system 104 may generate the user interface including the web form, and provide the user interface to the client computing device 108 for rendering and display thereon. The I/O circuit 180 is structured to receive communications from and provide

communications to the user of the client computing device 112 (e.g., the user). In this regard, the I/O circuit 180 is structured to exchange data with the processing circuit 178 to provide output to the user and to receive input from the user. As a result, the I/O circuit 180 may include a display that may be manipulated by the application. In some embodiments, the I/O circuit 180 may also include a keyboard, a mouse, a joystick, a touch screen, touch areas, soft keys, a microphone, a speaker, a vibration mechanism, a sensor, a RFID scanner, or other input/output devices described herein.

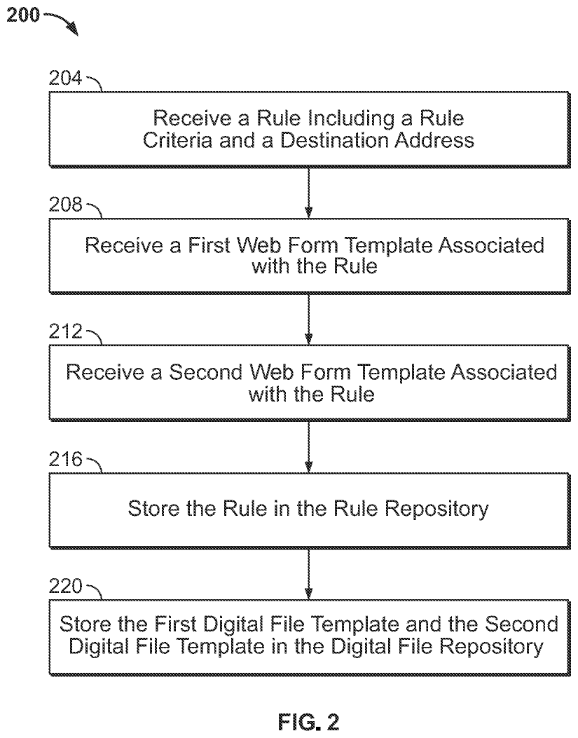

Referring now to FIG. 2, a method 200 of receiving and storing a rule and multiple web form templates is shown, according to an example embodiment. Method 200 can be carried out by the system of FIG. 1. More particularly, the method 200 can be carried out by the processing circuit 128 of the provider computing system 104 and through communication with the client computing devices 112.

Method 200 commences at step 204 at which the provider computing system 104 receives a rule (also referred to as an event) from one of the client computing devices 112. In some embodiments, the rule may be received from a client computing device 112, in response to the client computing device 112 providing admin-level credentials (e.g., an admin username and matching password, an admin username and 2-factor authentication, etc.). The rule may include multiple rule criteria. For instance, the rule may include medical product data or identifier (e.g., an NDC), a case dataset state or stage (e.g., closed, submitted, quality review passed, etc.), an adverse event (e.g., a MedDRA term and code, etc.), a seriousness (e.g., serious-results in death, serious, non-serious, etc.), a report type (e.g., spontaneous, post-marketed, from study, etc.), and other criteria that match case data described herein (e.g., a reporter criteria, a patient criteria (e.g., is pregnant, is Male, etc.). Likewise, the rule may include a destination address (e.g., the reporter email “johnsmith@gmail.com,” a specific FTP address, a specific IP address, etc.), a timeframe or number of days between attempts, a total number of attempts to make, and a rank or order. For instance, a specific rule (e.g., “Drug X—Arm Pain Follow-up Questionnaire) may include multiple rule criteria including the NDC of Drug X, the MedDRA code associated with Arm pain. Further, the specific rule may include an order of “1” and the destination address of “johnsmith@gmail.com,”.

Once the provider computing system 104 has received the rule, the method 200 proceeds to step 208, at which the provider computing system 104 receives a first web form template associated with the rule. The first web form template may be received from one of the client computing devices 112 (e.g., the same client computing device 112 that provided the rule, a different client computing device 112 than the client computing device 112 that provided the rule, etc.). Further, the web form template may be a template that defines a specific web form. In some embodiments, the web form template may be the same file type as the web form. In other embodiments, the web form template may be a different file type than the web form. Further, the web form template may be at least one of a Word file (DOC), an Excel file (XLS), a Comma-separated value (CSV) file, an XML file, a PDF file, a hypertext markup language (HTML) file, a Cascading Style Sheet (CSS) file, a TIFF file, a text (TXT) file, or other files configured to layout and define the web form. Additionally, the web form template may include or identify a specific language the web form is to include, a specific country or countries in which the web form is to be used, an ad-hoc question option or preference, an ad-hoc section option or preference, a subject field, text fields, text labels, and the like. For instance, the web form template may include multiple text sections, each section including text data such as a text label (e.g., “When you took Drug X, were you pregnant?”) and text field in which a response may be added. Likewise, the web form template may include an ad-hoc section option, which when set to “yes” or “on,” allows one or more users to add a text section to the generated web form. Further, the web form template may include an ad-hoc question or field option, which when set to “yes” or “on,” allows one or more users to additional text data (e.g., a question, a text label and a text field, etc.) to one of the text sections of the web form.

In some embodiments, the web form template may further specify the structure or layout of a delivery agent or vehicle of the web form (also referred to as a correspondence) (e.g., an email through which the web form may be provided or linked to) as well as text data to be included in the correspondence. For instance, the web form template may include an email subject line, an email header (e.g., “Dear xxx”), an email body (e.g., “We have received a reporter . . . ”, etc.), an email signature (e.g., “We appreciate your cooperation. Sincerely . . . ”), as will be described further herein. In some embodiments, the web form template may include the text data of the correspondence in multiple languages. For instance, the web form template may include the email header in multiple languages, the email body in multiple languages, the email signature in multiple languages, etc. Then, when generating the correspondence, the provider computing system 104 may select the text data which corresponds to the language of the reporter. For instance, in response to the reporter's primary language being French, the provider computing system 104 may generate the correspondence to include the text data which is in French.

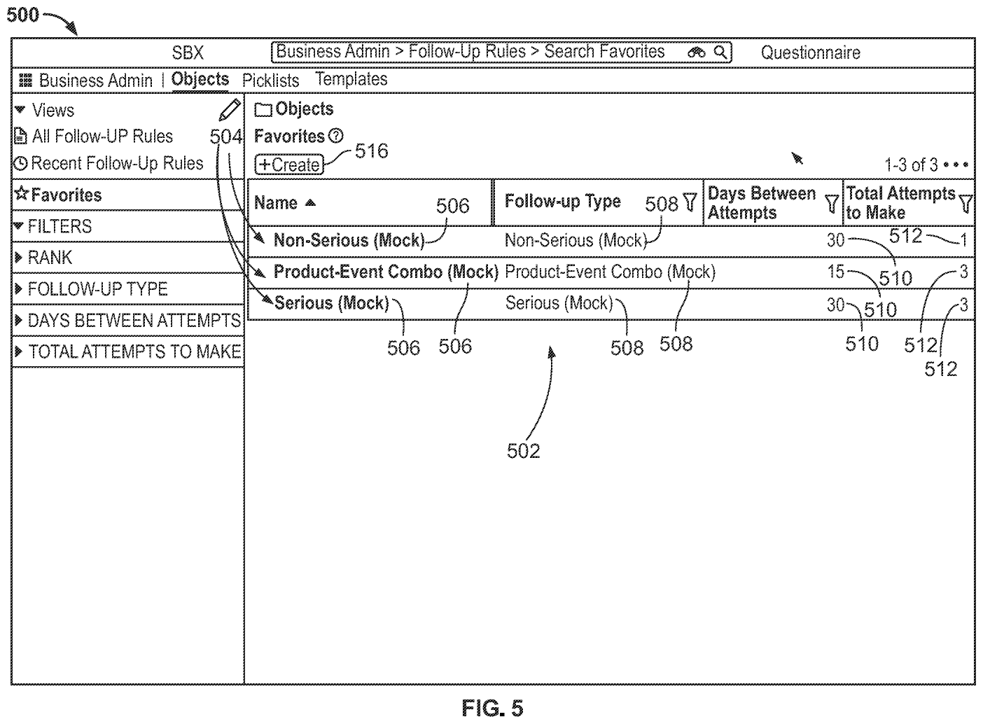

Once the provider computing system 104 has received the first web form template, the method 200 proceeds to step 212 at which the provider computing system 104 receives a second web form template associated with the rule. The second web form template may be received from one of the client computing devices 112 (e.g., the same client computing device 112 that provided the rule, the same client computing device 112 that provided the first web form template, a different client computing device 112 than the client computing device 112 that provided the rule, etc.). The second web form template may be similar to the first web form template (i.e., include the same or similar data as the first web form template). For instance, the web form template may be a template that defines a specific web form. In the example shown in FIG. 5, the first web form template may define a product-specific web form that is provided to any reporter who reported an adverse event associated with the specific medical product (e.g., “Cholecap Questionnaire”), whereas the second web form may define a product and adverse event pair-specific web form that is provided to any reporter who reported the specific adverse event associated with the specific medical product (e.g., “WonderDrug Product—Event Questionnaire”).

In some embodiments, the second web form template may define the same web form as the first web form template, but include text sections and text data that is in a different language. For instance, the first web form template may include multiple text sections, each text section including text data in a first language (e.g., “Were you pregnant when you took Drug X?”). Similarly, the second web form template may include multiple text sections, each text section including text data in a second language (e.g., “¿Estaba embarazada cuando tomó el Drug X?”). The web forms may be the same web forms, but include different languages. In other embodiments, the first web form template may include multiple text sections including a first text section in a first language and a second text section in a second language. Then, when generating the web form based on the first web form template, the provider computing system 104 may select a specific text section to be included in the web form, based on the language of the recipient of the web form, as will be described further herein.

Once the provider computing system 104 has received the second web form template, the method 200 proceeds to step 216 at which the provider computing system 104 stores the rule in the rule repository 132. As described herein, the rule may be stored in association with or a digital link to the first web form template and the second web form template, as well as the user or customer which provided the rule.

Once the provider computing system 104 has stored the rule in the rule repository 132, the method 200 proceeds to step 220 at which the provider computing system 104 stores the first web form template and the second web form template in the web form repository 136. In some embodiments, the first web form template and the second web form template are stored in a web form template repository (not shown), which is separate from the web form repository 136 where web forms are stored.

In some embodiments, during the method 200, the provider computing system 104 may receive additional rules and/or web form templates. For instance, the provider computing system 104 may receive a first rule including first rule criteria and a first destination address, and a second rule including second rule criteria and a second destination address. Then, the provider computing system 104 may store each of the rules in the rule repository 132. In other embodiments, the provider computing system 104 may receive 3, 4, 5, 6, or more rules during step 200. Likewise, the provider computing system 104 may receive three web form templates. The first web form template may include text data in a first language; the second web form template may include text data in a second language; and the third web form template may include text data in a third language. The provider computing system 104 may then store each of the web form templates in the web form repository 136. In other embodiments, the provider computing system 104 may receive 3, 4, 5, 6, or more web form templates during the method 200. For example, the provider computing system 104 may receive a first rule which is associated with a received first web form template and a received second web form template. Next, the provider computing system may receive a second rule which is associated with the received first web form template and a received third web form template. Further, the provider computing system 104 may receive a third rule which is associated with the received first web form template and a received fourth web form template. The first web form template may be associated with a specific medical product (e.g., Drug X Questionnaire), whereas the second through fourth web form templates may be each associated with a specific medical product-adverse event pair (e.g., Drug X-Arm Pain Questionnaire, Drug X-Headache Questionnaire, Drug X-Cardiac Arrest Questionnaire, etc.).

In some embodiments, steps 208, 212, and 220 may take place prior to step 204 and 216. For instance, the provider computing system 104 may receive the first web form template and the second web form template, and then store the first web form template and the second web form template in the web form repository 136. Then, the provider computing system 104 may receive a rule which identifies or references the first web form template and the second web form template. Then, the provider computing system 104 may store the rule in the rule repository 136 including an association or link to each of the web form templates.

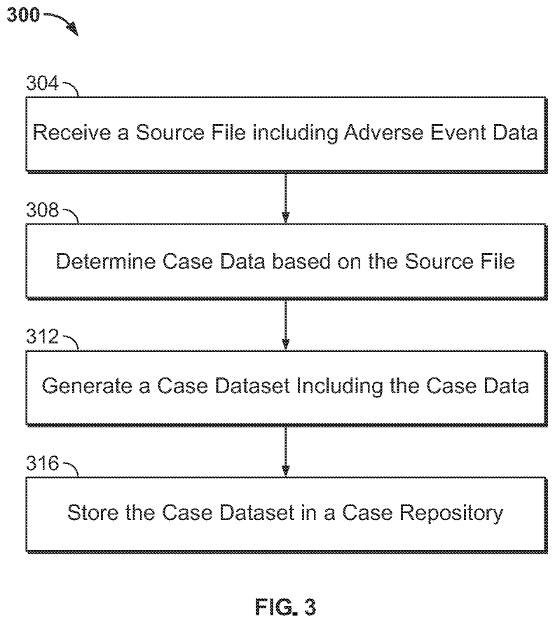

Referring now to FIG. 3, a method 300 of generating a case dataset is shown, according to an example embodiment. While different overall, it should be understood that any steps or discussion of the method 300 may be applied or included within the method 200 or the method 400, and vice versa, and that such combinations are included within the scope of the present disclosure. For example, the method 200 may include any of the steps 304-316 or steps 404-452, after or before any steps included in the method 200, and the method 300 may include any of the steps 204-220, after or before any of the steps included in the method 300. In a specific example, the provider computing system 104 may perform the method 200 (e.g., receive a rule, receive a first web form template, receive a second web form template, store the rule, store the web form templates), then perform the method 300 (e.g., receive a source file, determine case data based on the source file, generate a case dataset, etc.) and then perform the method 400. Method 300 can be carried out by the system of FIG. 1. More particularly, the method 300 can be carried out by the processing circuit 128 of the provider computing system 104 and through communication with the partner computing systems 108 and the client computing devices 112.

Method 300 commences at step 304 at which the provider computing system 104 receives a source file including adverse event data. The source file and the adverse event data may be associated with one or more adverse events. For instance, the source file may include adverse event information for each adverse event. Further, the source file may be received from one of the client computing devices 112 or one of the partner computing systems 108. In some embodiments, the source file may be an E2B (R2 or R3) XML file received via an AS2 Gateway communication from the one of the partner computing systems 108 or the client computing devices 112. In other embodiments, the source file may be received from one of the partner computing systems 108 via an application programming interface (API) of the provider computing system 104. In other embodiments, the source file may be at least one of a PDF file, an Excel file, a CSV file, an email, or other file types described herein. The adverse event data may identify or include medical product or substance data (e.g., a substance name, a medical product slang name or term, a medical product trade name, a NDC, a medical product identifier, a dosage, a country of origin, a strength, a lot number, a route of administration, etc.), study data (e.g., a study identifier), an adverse event term and code (e.g., a MedDRA term and code), reporter data (e.g., a reporter name, a reporter country, a reporter address or contact information (e.g., email, phone number, IP address, FTP address, etc.)), patient data (e.g., patient initials, patient address or contact information), a report type (e.g., spontaneous, from study, from marketed medical product, etc.), a seriousness of the adverse event, and the like.

In some embodiments, the source file may be a web form, as described further herein with regard to the method 400. For instance, the provider computing system 104 may generate a web form based on a web form template. Next, the provider computing system 104 may generate a public access link associated with the web form and output the public access link. Then, in response to receiving a request based on the public access link, the provider computing system 104 may output the web form to enable display on a user interface. The user interface may include a series of questions, which collect the adverse event data of the source file. Then, in response to receiving multiple responses via the web form, the provider computing system 104 may proceed to step 308.

Once the provider computing system 104 has received the source file, the method 300 proceeds to step 308 at which the provider computing system 104 determines or generates case data based on the source file. In some embodiments, the provider computing system 104 may determine the case data based at least partially on the adverse event data. For instance, the provider computing system 104 may transform or add each piece of adverse event data to a specific field or portion of the case data. In one example, an adverse event term of the adverse event data may be added to an adverse event field of the case data. In this regard, the case data may include at least a portion of the adverse event data of the source file. In another example, the provider computing system 104 may determine at least a portion of the case data by transforming adverse event data that is in an incorrect format into a correct format (e.g., “SE” to “Sweden”). In some embodiments, at step 308, the provider computing system 104 may further generate a priority of the case based on the adverse event data, a rank of the adverse events associated with the current case, a rank of the medical products, and the like.

Additionally, to determine case data at step 308, the provider computing system 104 may retrieve the medical product and/or study data of the medical product and/or study identified in the source file from a medical product repository (not shown) or study repository (not shown) and determine case data by matching the adverse event data with the medical product and/or study data. For example, the adverse event data of the source file may indicate that the patient consumed Y Milliliters of a medical product X on Mar. 23, 2000. The provider computing system 104 may then search the medical product repository (not shown) for medical product data pertaining to medical product X and return additional values and medical product data (e.g., dosage of medical product X, the chemical formula of medical product X, expected side effects of medical product X, a clinical study that medical product X is currently being studied in, a clinical study #, pertaining to medical product X, and the like) as previously provided by the user. This additional medical product data and study data may then be included in the case data. In another example, the adverse event information may indicate that the patient consumed medical products A, B, and C on Mar. 23, 2000. The provider computing system 104 may determine that the user has not provided any medical product data pertaining to medical products A and B but has provided medical product data pertaining to medical product C. Accordingly, the provider computing system 104 may retrieve the medical product data pertaining to medical product C as well as assign a ranking of one to the medical product C, while assigning a ranking of two or three to the medical products A and B. The ranking may then be used to list or sort the medical product data within the case dataset (i.e., a ranking of one appears higher than a ranking of two, and so on) and on any user interfaces.

Once the provider computing system 104 has determined the case data based on the source file, the method 300 proceeds to step 312 at which the provider computing system 104 generates a case dataset including the case data. In some embodiments, at step 312, the provider computing system 104 may generate a case data object (also referred to as a data record) associated with or including the case identifier of the case. In this regard, the case dataset may include a case data object which may be used as a vehicle or apparatus for the case dataset and storing the case data within the case repository 134 of the provider computing system 104. For instance, the provider computing system 104 may determine or generate the case data and then populate the case data object with the case data.

In some embodiments, before steps 308 or 312, the provider computing system 104 may search the case repository 134 for potential duplicate case datasets of the case dataset to be generated. For instance, the provider computing system 104 may search the case repository 134 for cases that include a similar or the same case identifier, medical product(s), adverse event(s), report date, reporter name, and the like. In response to returning one or more potential duplicate case datasets, the provider computing system 104 may provide the potential duplicate case datasets and the adverse event data of the source file (or the newly generated case data) for review and comparison. Then, in response to receiving an indication the case datasets are not duplicates, the provider computing system 104 may proceed to step 308 or 312.

Once the provider computing system has generated the case dataset, the method 300 proceeds to step 316 at which the provider computing system 104 stores the case dataset (e.g., as a case data object) in the case repository 134. For instance, the provider computing system 104 may add or provide the case dataset to the case repository 134 for storage therein.

In some embodiments, the newly generated case dataset may include a state or stage of “New.” In other embodiments, based on the generated case data (e.g., for a case that includes a seriousness of non-serious and an expectedness of expected), the provider computing system 104 may promote output the case dataset including at least a portion of the case data and set the stage of the case dataset to a specific stage (e.g., “complete” or “submitted”). For instance, the provider computing system 104 may output the case dataset as an E2B (R2 or R3) XML file to one or more of the partner computing systems 108 via an AS2 Gateway communication. In some embodiments, after step 316, the provider computing system 104 may select the newly generated case dataset and provide it to one of the client computing devices 112. Then, in response to receiving a verification of the case dataset, the provider computing system 104 may output the case dataset to one of the partner computing systems 108 and change the state of the case dataset to a specific stage (e.g., complete).

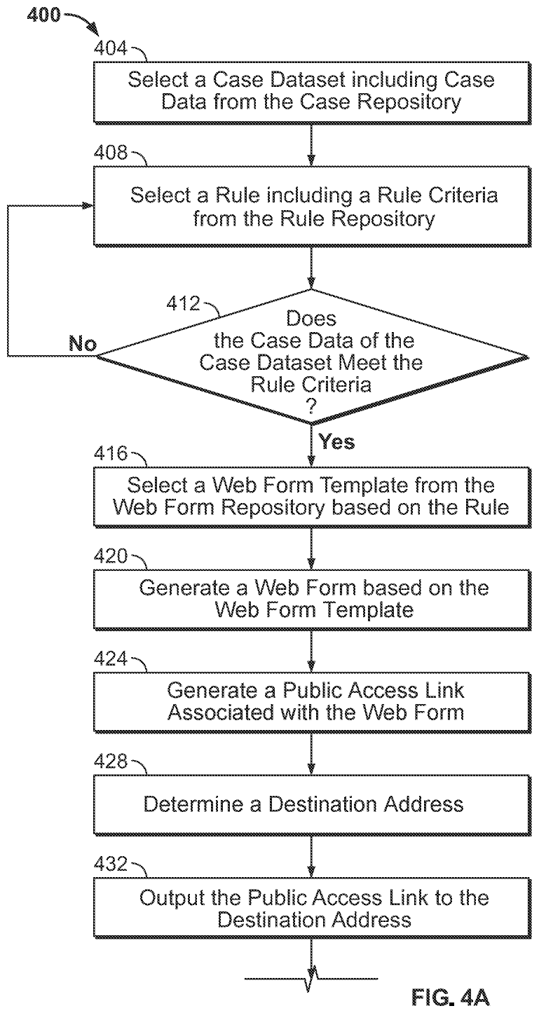

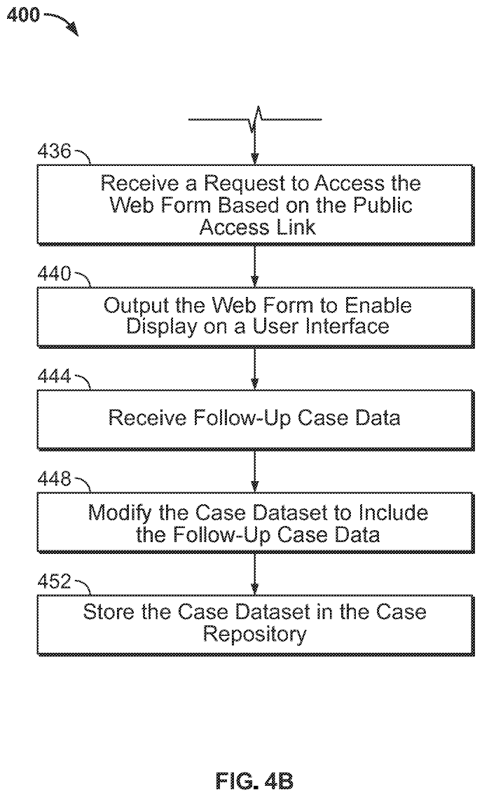

Referring now to FIGS. 4A-4B, a method 400 of generating a web form and receiving follow-up case data via the web form is shown, according to an example embodiment. Method 400 can be carried out by the system of FIG. 1. More particularly, the method 400 can be carried out by the processing circuit 128 of the provider computing system 104 and through communication with the partner computing systems 108 and the client computing devices 112.

Method 400 commences at step 404 at which the provider computing system 104 selects a case dataset including case data from the case repository 134. In some embodiments, the provider computing system 104 may select the case dataset, in response to the case dataset reaching a specific state (e.g., complete, approved, submitted, new, etc.). In other embodiments, the provider computing system 104 may select the case dataset, in response to the case dataset being submitted to one of the partner computing systems 108. In some embodiments, the provider computing system 104 may select multiple case datasets at step 404.

Once the provider computing system 104 has selected the case dataset from the case repository 134, the method 400 proceeds to step 408 at which the provider computing system 104 selects a rule including rule criteria from the rule repository 132. In some embodiments, the provider computing system 104 may select the rules, from the rule repository 132, in the order of the rules. For instance, as described herein each rule may include an order or rank (e.g., rank or order 1, rank or order 2, rank or order 3, and so on). In this regard, the provider computing system 104 may first select the rule including the rank or order 1, and then proceed through the method 400 to step 412 at which the provider computing system 104 determines if the case data of the case dataset fulfills or meets the rule criteria. If the case data fulfills or meets the rule criteria, the method 400 may proceed to step 416. If the case data does not fulfill or meets the rule criteria, the method may proceed to step 408 and select a second rule from the rule repository 132. The second rule may have a rank or order of 2. This process may be repeated (e.g., the rule with order 3, the rule with order 4, and so on) until a match is found. If no rule including rule criteria that match or meet the case data is found, the method 400 may end.

In some embodiments, the rule may include a destination address. In other embodiments, the case dataset may include a destination address (e.g., an email address of the reporter in the reporter data, etc.). In this regard, the destination address may be determined based on at least one of the rule or the case dataset. In some embodiments, each web form template may include a destination address such that a specific rule may result in outputs to multiple destination addresses. For instance, a rule may be associated with or digitally linked to a first web form template and a second web form template. Accordingly, in response to the rule being met, the provider computing system 104 may output a first web form to the first destination address of the first web form template and a second web form to the second destination address of the second web form template.

At step 412, the provider computing system 104 may determine if the case data of the case dataset matches the rule criteria of the rule. To determine, if the case data meets or fulfills the rule criteria, the provider computing system 104 may determine if the fields or pieces of case data identified in the rule criteria are the same as specified in the rule criteria. For instance, the rule criteria may include a specific medical product (e.g., as identified by NDC), a specific adverse event (as identified by MedDRA term and code), and a specific seriousness (e.g., results in death). Accordingly, in response to each of the rule criteria matching or being the same as the respective pieces of case data (e.g., the medical product data of the case data includes the same NDC as the rule criteria, the adverse event of the case data includes the same MedDRA code as the case criteria, and the seriousness of the case data is the same as the seriousness of the rule criteria), the provider computing system 104 may determine the rule criteria is met or matched by the case data. In other embodiments, provider computing system 104 may determine the rule criteria is met, in response to a single rule criteria matching the case data of the case dataset (e.g., the medical product data of the case data includes the same NDC as the rule criteria, but the adverse event of the case data and the seriousness of the case data are different than the rule criteria). Further, the rule may include a separate action or web form template for each specific combination of rule criteria being met (e.g., a first web form template if a first rule criteria is met, a second web form template if a second rule criteria is met, and so on).

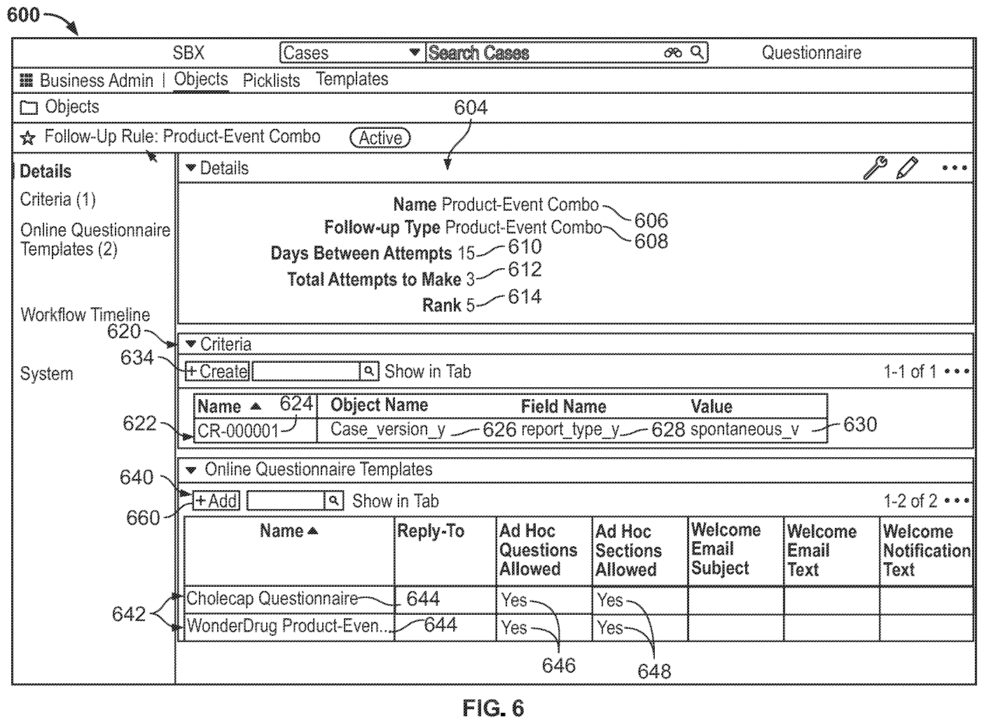

If, at step 412, the provider computing system 104 determines the case data of the case dataset does not meet the rule criteria, the method 400 may proceed back to step 408 where a different rule is selected from the rule repository 132. In comparison, if, at step 412, the provider computing system 104 determines the case data of the case dataset meets the rule criteria, the method 400 may proceed to step 416 where the provider computing system 104 selects a web form template from the web form repository 136 based on the rule. As described herein and shown in FIG. 6, each rule may be associated with or digitally connected (e.g., including a link or uniform resource locator (URL) to, including a reference pointer to, etc.) to a one or more web form templates. Accordingly, at step 416, the provider computing system 104 may select the associated web form template from the web form repository 136. If the rule is linked to multiple web form templates, the provider computing system 104 may select each from the web form repository 136, at step 416.

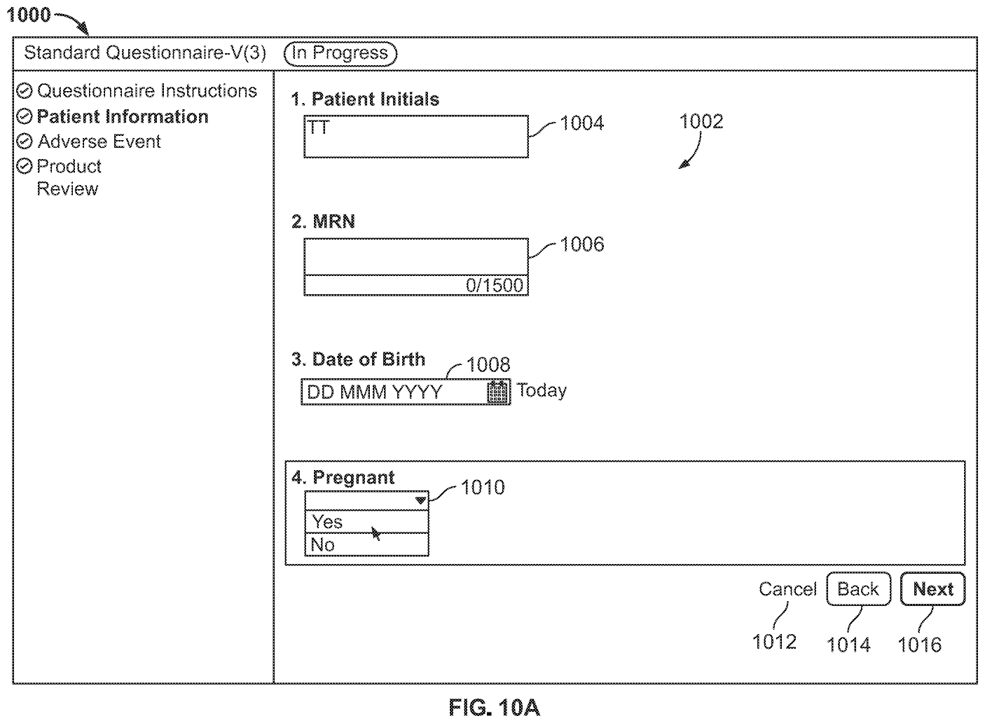

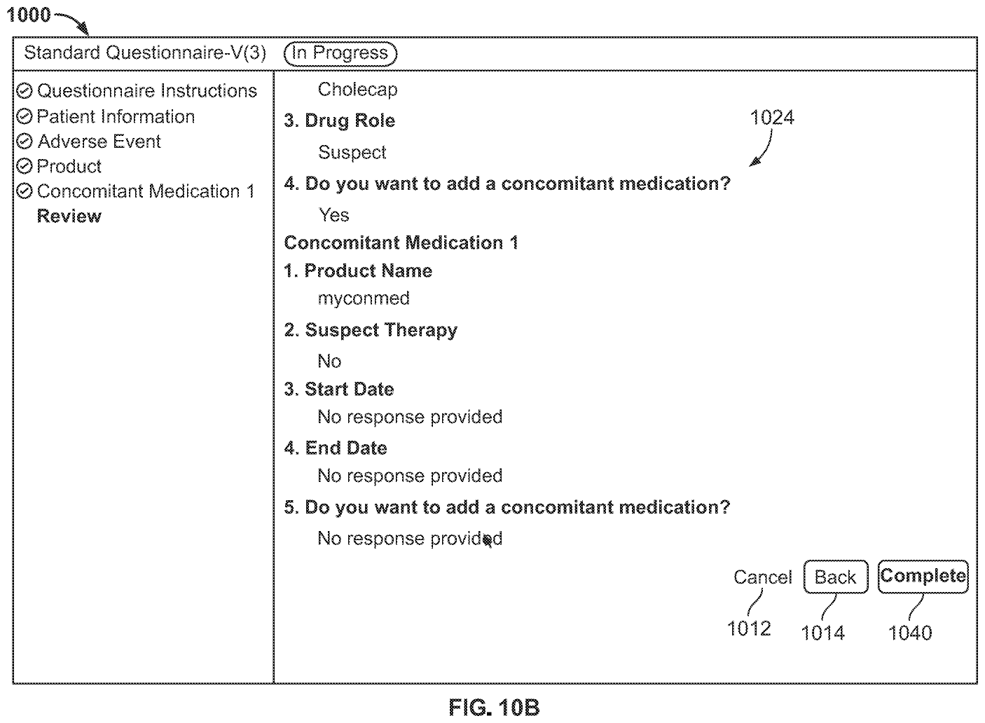

Once the provider computing system 104 has selected the web form template from the web form repository 136, the method 400 proceeds to step 420 at which the provider computing system 104 generates a web form based on the web form template. For instance, the provider computing system 104 may generate the web form defined by the web form template. In some embodiments, the provider computing system 104 may generate the web form based on the web form template and the case dataset. For instance, the provider computing system 104 may generate the web form defined by the web form template and populate it with case data of the case dataset (as may be indicated or defined in the web form template). For instance, the web form may include a “patient initials” text question. Accordingly, the provider computing system 104 may populate the “patient initials” text section with the patient initials of the case data (e.g., “TT”, see FIG. 10A), because the case dataset already includes the patient's initials. In another example, the web form may include an “adverse event” text question. Accordingly, the provider computing system 104 may populate the “adverse event” text section with the adverse event reported in the case data (e.g., “Arm Pain localized to the elbow,” MedDRA term “Arm Pain”, etc.). In another example, the web form may include an “medical product” text question. Accordingly, the provider computing system 104 may populate the “medical product” text section with the medical product data reported in the case data (e.g., “Drug X—300 mL subcutaneously on Jan. 1, 2024, at approx. 3 PM,” etc.). In this regard, the web form template may define the case data that is to be included or populated in the specific text sections of the web form. Then, when generating the web form, the provider computing system 104 may populate the web form with the case data based on the case dataset and the web form template.

The web form or web page may include a digital file including at least one of a Word file (DOC), an Excel file (XLS), a Comma-separated value (CSV) file, an XML file, a PDF file, a hypertext markup language (HTML) file, a Cascading Style Sheet (CSS) file, a TIFF file, a text (TXT) file, or other files described herein and may include a digital FUQ which is designed to gather addition information (e.g., follow-up case data) about a specific SAR or case dataset. For instance, a patient may experience a SAR while taking a medical product in a clinical trial. A doctor may report the SAR, via email. Then, at a later date, the provider computing system 104 may generate the web form, which is a FUQ, including multiple text sections to gather additional information about the SAR. In one specific example, the web form may include an HTML file which defines the boundaries of the web form, a CSS file which defines the layout, spacing, and positioning of elements (e.g., text sections) of the web form, and multiple records or pieces of data (e.g., case data, text data, etc.) which define the questions and certain prepopulated answers of the web form. An example web form is shown in FIGS. 10A-10B.

Additionally, as described herein, the provider computing system 104 may generate the web form based on the web form template and the language of the reporter of the case data. For instance, the source file may be received, at step 304, from a reporter (e.g., via a digital communication). The reporter may include a specific language in which they communicate or a country in which they reside. Alternatively, the reporter may provide the source file including text data in a specific language, which is then assumed to be the reporter's language of communication. This language or country may be stored in the reporter data of the case data. Accordingly, each web form template may be multilingual and include multiple text sections, each text section including text data in a specific languages. For instance, a web form template may include a first text section including text data in a first language (e.g., English), a second text section including text data with the same meaning as the first text section (e.g., the same questions) but in a second language (e.g., Mandarin Chinese), a third text section including text data with the same meaning as the first text section (e.g., the same questions) but in a third language (e.g., French). Then, based on the reporter's language of the case data being French, the provider computing system 104 may generate the web form to include the third text section of the web form template.

In some embodiments, at step 420, the provider computing system 104 may generate one or more files associated with the form. For instance, the provider computing system 104 may generate an HTML file which defines the boundaries of the web form, a CSS file which defines the layout, spacing, and positioning of elements (e.g., text sections) of the web form, and/or the records or data to be included in the web form (e.g., the text sections of the web form, the text data or questions of the text sections, etc.).

In some embodiments, when generating the web form, the provider computing system 104 may translate the text data of the web form template from a first language to a second language, based on the web form template and the language of the reporter. For instance, the web form template may include multiple text sections including text data in a first language (e.g., English). Further, the provider computing system 104 may determine the language of the reporter of the case dataset is a second language (e.g., Japanese) based on the reporter data of the case dataset (e.g., based on the primary language of the reporter). Accordingly, the provider computing system 104 may translate the text data of the multiple text sections into a second language. The provider computing system 104 may then generate the web form to include each of the sections of the web form template. Each section including the text data in the second language.

In other embodiments, the rule selected at step 408 may be associated with multiple web form templates (e.g., a first web form template including text data in a first language (e.g., English) and a second web form template including text data in a second language (e.g., French), as described herein). Accordingly, at step 416, the provider computing system 104 may select each of the web form templates and determine or select one of the web form templates, based on the primary language of the reporter. For instance, in response to the reporter's language being English, the provider computing system 104 may select the first web form template. The web form may then be generated based on the selected web form template.

By providing for linguistically-selective generation of the web form, the present systems and methods provide for an improvement to case dataset follow-up web form generation and case dataset processing systems. For instance, in typical case dataset follow-up generation, a web form may be generated in a single language (e.g., English) which is then provided to reporter's who speak different languages thereby resulting in low conversion or response rates, and less accurate responses. In comparison, because the web form is generated to include text data in the language of the recipient (e.g., the reporter), the present systems and methods provide for improved engagement and more accurate follow-up case data. For instance, because the web form is generated to include text data in the language of the recipient, the present systems and methods tailor the file's language to the recipient resulting in the recipient being more likely to understand and engage with the web form, leading to better user experience and higher conversion or response rates, as well as requiring less processing power to follow-up on the web form multiple times. Likewise, because the web form is generated to include text data in the language of the recipient (e.g., the reporter), the present systems and methods result in more accurate responses (e.g., follow-up case data). For instance, by knowing and utilizing the language the recipient prefers, the present systems and methods provide for tailored questions and better context. This provides for improved and more accurate responses that are more aligned with the intended meaning of the follow-up questions.

In some embodiments, before step 420, the provider computing system 104 may receive a request to modify or add on to the web form from one of the client computing devices 112. The request may include a specific text section or question to be included in the web form. For instance, in response to the ad-hoc question option or preference of the web form template being set to “yes” or “on,” the request may include a specific ad-hoc question which is to be added to one of the text sections of the web form. In another example, in response to the ad-hoc section option or preference being set to “yes” or “on,” the request may include a specific ad-hoc text section including multiple questions or text data which is to be added to the web form. Then, at step 420, the provider computing system 104 may generate the web form based on the web form template and the request received from the client computing device 112. For instance, the web form template may include three specific text sections, each including two questions, while the request may include an additional text section including three questions. Accordingly, at step 420, the provider computing system 104 may generate the web form to include the three text sections of the web form template and the text section of the request received from the client computing device 112.

By prepopulating the web form with case data and allowing for customizable questions, the present systems and methods provide for an improvement to case dataset follow-up web form generation and case dataset processing systems. For instance, because the present systems and methods utilize prefilled or prepopulated questions, where the answer is already known, the present systems and methods provides for improved efficiency and data collection through dynamic content generation and reduced data entry errors. For instance, the present systems and methods provide for a tailored experience that adapts to previously received data, thereby only asking relevant follow-up questions keeping the user engaged and more likely to respond to the other questions of the web form, which results in higher response rates as well as a greater amount of follow-up case data. Likewise, by populating the web form with case data, the present systems and methods provide for reduced data entry errors. For example, prepopulating the web form with case data eliminates the risk of typos, inconsistencies, and missing data due to manual entry errors, thereby resulting in less time, memory, and processing power spent correcting or re-submitting forms, improving data quality and workflow efficiency.

In some embodiments, after generating the web form, the provider computing system 104 may store the web form in the web form repository 136. For instance, the provider computing system 104 may generate the web form based on at least one of: the web form template, the request received from one of the client computing devices 112, and the case dataset. Then, the provider computing system 104 may add the web form to the web form repository 136. In some embodiments, the web form and the web form template may be stored in separate repositories (e.g., the web form repository 136 and a web form template repository (not shown).)

Once the provider computing system 104 has generated the web form, the method 400 proceeds to step 424 at which the provider computing system 104 generates a public access link (e.g., hyperlink) associated with or to the web form. The public access link or URL may be a URL or web address that provides limited (e.g., single-use, use until completed, expirable use, etc.) access to a privileged website or the web form to the receiver of the public access link. For instance, to access the web form, a client computing device 112 may first complete a login process (e.g., provide login credentials including a username or password) to be verified. If the client computing device 112 is not verified, the provider computing system 104 may not provide access to the web form (e.g., display an error instead). In comparison, the public access link may provide access to the web form, without requiring a login process (e.g., just by clicking or navigating to the public access link). In some embodiments, at step 424, the provider computing system 104 may generate a public access user or username associated with the public access link, a use counter associated with the public access link, and/or one or more privileges associated with the public access link. Then, at or after step 424, the provider computing system 104 may store the public access link (and associated data (e.g., the username, the use counter, etc.)) and/or the web form in a public access repository (not shown). In some embodiments, in response to generating multiple web forms at step 420, the provider computing system 104 may generate multiple public access links (e.g., one for each web forms) at step 424. For instance, the provider computing system 104 may select a rule, at step 408, which is associated with or linked to multiple web form templates. Then, at step, 420, the provider computing system 104 may generate multiple web forms (e.g., one for each web form template). Then, at step 424, the provider computing system 104 may generate multiple public access links (e.g., one for each web form). Then, at step 432, the provider computing system 104 may output each of the public access links.

In some embodiments, the public access link or URL may further include an expiration parameter (e.g., signature) that is associated with a public access link expiration date and/or time. For example, the expiration parameter may be included in the URL and deactivate the URL after the public access link expiration date and/or time. As a result, if the recipient selects the URL including the expiration parameter after the public access link expiration date and/or time, the URL may be deactivated and not route the recipient to the web application or the web form. In another example, the expiration parameter may be associated with the use-counter or the use-until-completed counter. For example, the expiration parameter may be included in the URL and deactivate the URL after the public access link is used or accessed a specific number of times (e.g., as indicated and incremented by the use-counter). As a result, if the recipient selects the URL including the expiration parameter a specific number of times, the URL may be deactivated and not route the recipient to the web application or the web form. In another example, the expiration parameter may be included in the URL and deactivate the URL after the web form has been edited and submitted. As a result, if the recipient selects the URL including the expiration parameter after editing and submitting the web form, the URL may be deactivated and not route the recipient to the web application or the web form.

In some embodiments, to generate the public access link, the provider computing system 104 may generate a token associated with the public access link and the web form associated with the public access link, and store the token therein. The token may be utilized, by the provider computing system 104, to validate or authenticate the client computing device 112 from which the provider computing system 104 is receiving the public access link. For instance, a public access link may follow the form of “https://<vaultdns>/ui/pal?pal-token=<token>”, were the “<vaultdns>” is the domain name of the web form, and the “<token>” is the token generated by the provider computing system 104 and included in the public access link. In this embodiment, in response to receiving request to access the web form at step 436, the provider computing system 104 may authenticate the requesting client computing device 112 based on the token of the received public access link. For instance, the provider computing system 104 may search a token repository (not shown) for the token, and in response to returning the token, determine the public access link is authorized to view and edit the web form. In some embodiments, the public access link and the token may be stored in association with a status or state of the public access. For instance, in response to the public access link being activated or generated, the provider computing system 104 may set the status to active. Then, in response to the expiration of the public access link (e.g., the use counter being met, the expiration date/time, etc.), the provider computing system 104 may modify the status of the public access link to inactive. Then, in response to receiving a request to access the web form including the key associated with the public access link, the provider computing system may determine the public access link is inactive and not route the client computing device 112 to the web form (e.g., display an error message).

Once the provider computing system 104 has generated the public access link, the method 400 may proceed to step 428 at which provider computing system 104 may determine the destination address to which the public access link is to be provided. For instance, the provider computing system 104 may determine the destination address based on the rule (e.g., based on the destination address included in the rule). In another example, the provider computing system 104 may determine the destination address based on the reporter data of the case data. For instance, as described herein, the case data may include reporter data. The reporter data may identify a person or health care provider (HCP) who reported the adverse event and include a name of the reporter, a primary language used by the reporter, a secondary language used by the reporter, an occupation of the reporter (e.g., doctor, etc.), and a digital address of the reporter (e.g., email address, FTP address, IP address, etc.). Accordingly, the provider computing system 104 may determine the destination address based on the reporter data of the case dataset (e.g., based on the digital address of the reporter included in the reporter data).

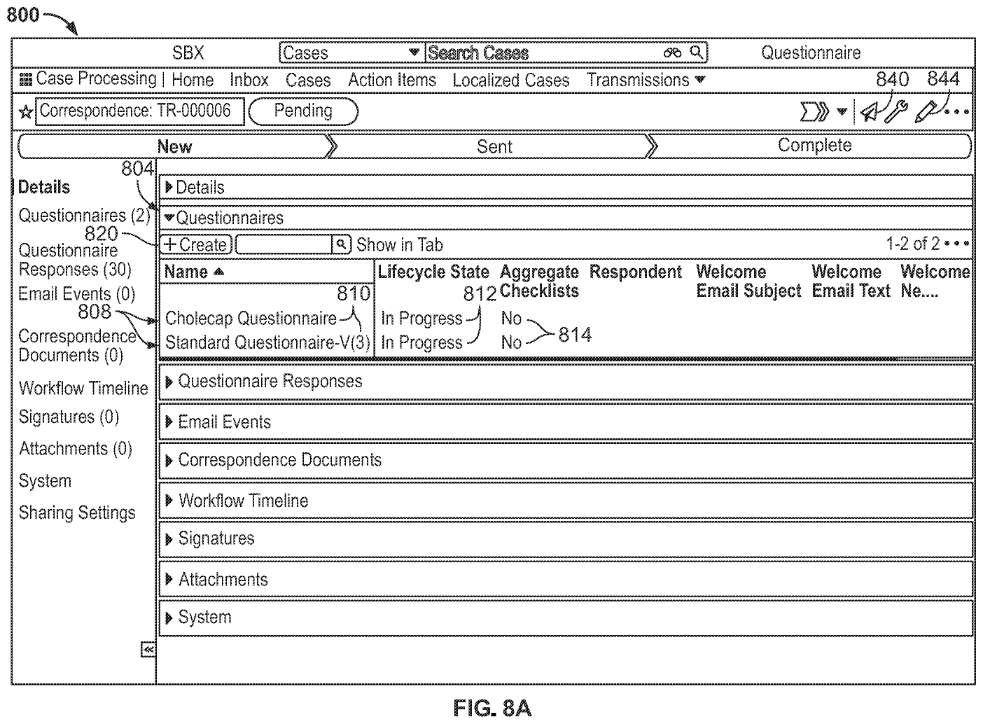

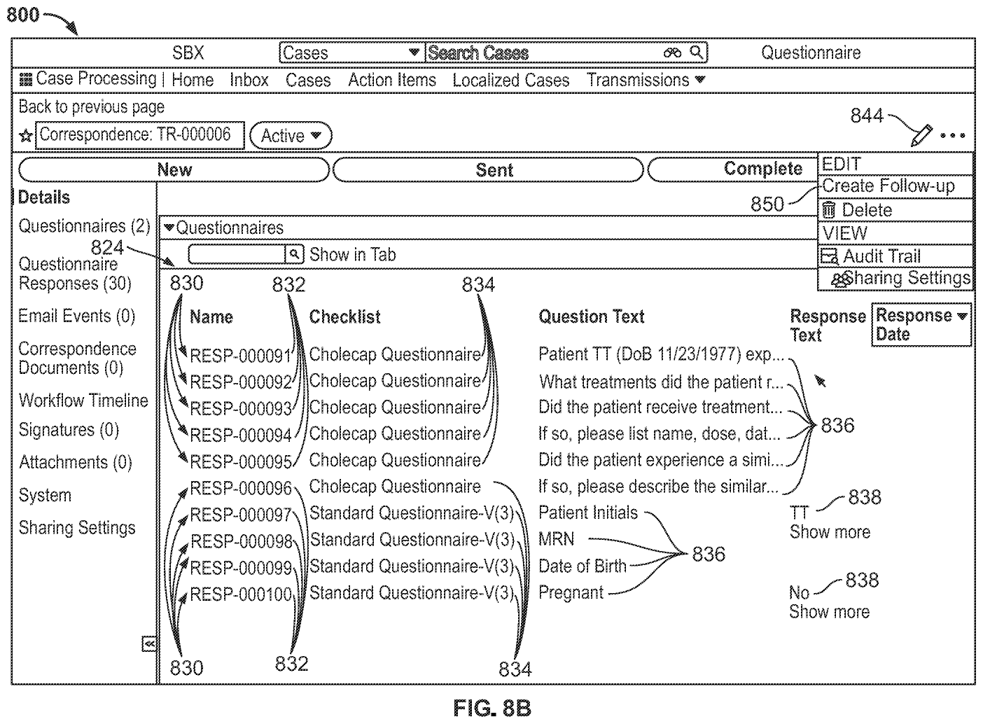

Once the provider computing system 104 has determined the destination address, the method 400 proceeds to step 432 at which the provider computing system 104 outputs the public access link to the destination address of the rule. For instance, the provider computing system 104 may output the public access link to a specific email associated with the reporter. In another example, the provider computing system 104 may output the public access link to a specific IP address associated with the reporter. In some embodiments, the public access link may be output to one of the client computing devices 112 or one of the partner computing systems 108. In some embodiments, before or at step 432, the provider computing system 104 may generate a delivery agent or vehicle of the public access link. For instance, the provider computing system 104 may generate an email including a subject line and a body including the public access link based on the rule or the associated web form template of the rule. For instance, FIG. 8 shows an example email, generated by the provider computing system 104, that includes the public access link therein. Then, at step 432, the provider computing system 104 may output the public access link by outputting or transmitting the delivery agent or vehicle including the public access link. In other embodiments, the delivery agent or vehicle may include a file share request or notification including the public access link, a text or digital message including the public access link, an instant message including the public access link, and the like.

Once the provider computing system 104 has output or transmitted the public access link, the method 400 proceeds to step 436 at which the provider computing system 104 receives a request to access the web form based on the public access link. For instance, in response to outputting the public access link, the recipient of the link (e.g., one of the client computing devices 112 may select the link and generate a request for the webpage or the web form of the digital access link. The provider computing system 104 may receive the request, determine if the URL is valid (e.g., based on the expiration parameter, based on the use parameter, etc.) and generate a webpage including the web form based on the digital access link, in response to the URL being valid. In this regard, after step 436, but prior to step 440, the provider computing system 104 may validate the requesting device based on the public access link and the parameters or tokens associated with the public access link. For instance, the provider computing system 104 may receive the public access link including a token. The provider computing system 104 may then search a token repository (not shown) for the token and determine it is associated with an active public access link. Then, in response, the provider computing system 104 may proceed to 440. In another example, the provider computing system 104 may validate the requesting client device 112 by determining the public access link is not expired based on the public access expiration date and the expiration parameter of the public access link as well as the current date. In another example, the provider computing system 104 may not validate or reject the requesting client device 112, in response to determining the use-counter has reached or is greater than a threshold use number (e.g., 5 uses, 10 uses, etc.). In another example, the provider computing system 104 may not validate or reject the requesting client device 112, in response to determining the web form has already been edited and submitted via the public access link.

Once the provider computing system 104 has received the request to access the web form, the method 400 proceeds to step 440 at which the provider computing system 104 may provide or output the web form to the requesting client computing device 112 for display on a user interface thereon. For instance, the provider computing system 104 may provide the generated web form to the requesting client computing device 112 to enable display on a webpage of the user interface of the requesting client computing device 112. FIGS. 10A-10B show an example user interface including a web form page 1000, as will be described further herein.

Once the provider computing system 104 has output the web form, the method 400 proceeds to step 444 at which the provider computing system 104 receives follow-up case data (also referred to as additional case data). For instance, the provider computing system 104 may receive the follow-up case data from the requesting client computing device 112 in response to the user of the client computing device 112 providing additional case data to the text sections of the user interface. The follow-up case data may include case data including reporter data, medical product data, patient data, adverse event data, seriousness data, etc. that was not received in the initial source file. In this regard, the case data is “follow-up case data” because it was received via a follow-up communication.

Once the provider computing system 104 has received the follow-up case data, the method 400 proceeds to step 448 at which the provider computing system 104 adds the follow-up case data to the case dataset. For instance, the provider computing system 104 may modify the case dataset to include the follow-up case data. In some embodiments, at or before step 448, the provider computing system may generate a new version of the case dataset (e.g., from version 1.0 to version 2.0, from version 1.0 to version 1.1, etc.), and the follow-up case data may be added to the new version of the case dataset. In some embodiments, when the originally received case data was wrong (e.g., wrong name, wrong seriousness, wrong adverse event, etc.), the provider computing system 104 may replace at least a portion of the case data with the follow-up case data. For instance, an adverse event, where a patient was hospitalized, may be reported in a source file. The source file may result in the generation of a case including a seriousness of “serious-results in hospitalization”. Then, as things progress, the patient may die, which may be communicated in a follow-up questionnaire. The provider computing system 104 may receive the follow-up case data indicating the patient died, and update the case dataset to include a seriousness of “serious-resulted in death.”

In some embodiments, prior to steps 444 and 448, the provider computing system 104 may including mapping preferences identifying one or more questions of the web form and mapped case data fields. For instance, the mapping file may map the specific question “Pregnant?” to a specific case data field (e.g., “patient_pregnancy_v”). In this regard, the mapping file may map each of the questions of the web form to a specific case data field. Then, at step 448, when adding the follow-up case data to the case data dataset, the provider computing system 104 may do so based on the mapping preferences. For instance, in response to the question including the answer “Yes,” the provider computing system may set the specific case data field (e.g., “patient_pregnancy_v”) to the value “Yes” based on the mapping preferences and the response included in the question identified in the mapping preferences. In some embodiments, the web form template may include the mapping preferences. For instance, the web form template may identify each of the questions of the web form and a corresponding mapped case data field. Then, when adding the follow-up case data to the case data dataset, the provider computing system 104 may do so based on the mapping preferences of the web form template. In other embodiments, the provider computing system 104 may receive the mapping preferences in a mapping file.

Once the provider computing system 104 has added the follow-up case data to the case dataset (and/or versioned the case dataset), the method 400 proceeds to step 448 at which the provider computing system 104 stores the modified (or versioned) case dataset in the case repository 134. In some embodiments, at or after step 448, the provider computing system 104 may output the case dataset including at least a portion of the case data and the follow-up case data to one of the partner computing systems 108. For instance, the provider computing system 104 may output the case dataset as an E2B (R2 or R3) XML file to one or more of the partner computing systems 108 via an AS2 Gateway communication.

Referring now to FIGS. 5-10B, user interfaces shown and displayed to the user of the one or more client computing devices 112 during the methods 200, 300, and/or 400 are shown, according to example embodiments. As described herein, the user interfaces of FIGS. 5-10B may be one or more of web interfaces generated by the provider computing system 104 and rendered by each of the client computing devices 112 as part of a web application or graphical user interfaces downloaded and generated by each of the client computing devices 112 as part of a software application (e.g., a mobile application, etc.). Further, the user interfaces shown on FIGS. 5-10B allow for communication between the user) and the provider computing system 104 via the respective client computing device 112 (specifically via the I/O circuit 180). Through interaction with the various user interfaces, the user may provide user input, feedback, and other data requested by the provider computing system 104. In this regard, it should be understood that each interaction described herein by the user with the user interfaces of FIGS. 5-10B may be provided to one or more of the client computing devices 112 and then transmitted to the provider computing system 104 and that each action described herein as occurring to the respective client computing device 112 (e.g., navigating to a certain page, generating a popup, etc.) may be performed by the provider computing system 104.

Referring now to FIG. 5, a rule management page 500 which can be displayed on a display the I/O circuit 180 of the client computing devices 112, is shown. In general, the rule management page 500 provides the user an interface to setup, modify, and manage rules for a specific customer. As shown, the rule management page 500 includes a rule listing or section 502 including multiple rule representations 504 and a create button 516. To render or generate the rule management page 500 on the client computing device 112, the provider computing system 104 may provide the rules, of the rule repository 132, and associated data to the client computing device 112. In this regard, it should be understood that each of the sections, fields, or buttons of the rule management page 500 may be or included in the rules described herein.

The rule listing 502 provides the user of the respective client computing device 112 with an interface to set, manage, and update the rules of the rule management page 500. As shown, the rule listing 502 includes the rule representations 504 and the create button 516. The create button 516 is a selectable button that, when selected, causes the client computing device 112 to generate and provide a request to the provider computing system 104 to generate a new empty or blank rule. The rule may be represented by a new rule representation 504 in the rule listing 502. In some embodiments, in response to selecting the create button 516, a popup page or section (not shown) may be generated and displayed on the rule management page 500. The popup page may receive rule data including a type, a name of the rule, a number of days between attempts, a total number of attempts, an order, and the like. The client computing device 112 may then generate and provide a request to the provider computing system 104 to generate a rule including the rule data described above. The request may include the rule data of the popup page.

The rule representations 504 may each represent a specific rule and include the rule data or fields which they represent. For instance, each rule representation 504 is shown to include a name field 506, a follow-up type field 508, a number of days between attempts field 510, and a total number of attempts to make field 512. In some embodiments, each rule representation 504 further includes a rank or order field (not shown), a rule criteria field (not shown), and an associated or linked web form template field (not shown). In some embodiments, each rule representation 504 may include a different rank or order field, such that no two rule representations 504 include the same rank or order. For instance, a first rule representation 504 (e.g., the rule representation 504 the highest on the rule management page 500) may include a rank or order field of “1”. Then, a second rule representation 504 (e.g., the rule representation 504 directly below the first rule representation 504 on the rule management page 500) may include a rank or order field of “2”). Then, the last rule representation 504 (e.g., the rule representation 504 the lowest on the rule management page 500) may include the highest number in the rank or order field.

The name field 506 may be a field through which the user of the respective client computing device 112 can review, edit, and/or initially set the name of the rule associated with the rule representation 506 which may then be sent by the respective client computing device 112 to the provider computing system 104 for storage (e.g., in the rule repository 132). Further, the name field 506 may be a selectable button or link that, when selected, causes the client computing device 112 to navigate to a rule page 500 for the rule of the rule representation 504.

Similarly, the follow-up or rule type field 508 may be a field through which the user of the respective client computing device 112 can review, edit, and/or initially set a type of the rule associated with the rule representation 506 which may then be sent by the respective client computing device 112 to the provider computing system 104 for storage (e.g., in the rule repository 132). As described herein, the type of the rule may be an option or preference which sets a template or data layout for the rule. For instance, a rule with the type “non-serious” may automatically include at least one rule criteria including a seriousness of “non-serious.” In another example, a rule with the type “product-event combo” may include at least two rule criteria including a medical product, which may be set by the user, and an adverse event term or code, which may be set by the user. In another example, a rule with the type “serious” may include multiple rule criteria including a seriousness of “serious-results in death,” “serious-results in hospitalization”, and the like.

The number of days between attempts field 510 and the total number of attempts to make field 512 may each be a field through which the user of the respective client computing device 112 can review, edit, and/or initially set a number of days between digital communication attempt and the total number of digital communication attempts to make, respectfully, of the rule associated with the rule representation 506 which may then be sent by the respective client computing device 112 to the provider computing system 104 for storage (e.g., in the rule repository 132).

Referring now to FIG. 6, a rule page 600 which can be displayed on a display the I/O circuit 180 of the client computing devices 112, is shown. In general, the rule page 600 provides the user an interface to modify and manage a specific rule of the multiple rules of the customer. To be navigated to the rule page 600, the user of the respective client computing device 112 may select the name field 506 of the rule representation 504. In response to the selection, the provider computing system 104 may receive an indication, from the respective client computing device 112, and generate the rule page 600 including the rule data of the selected rule. The provider computing system 104 may then provide the rule data and the rule page 600 to the respective client computing device 112 for display thereon. As shown, the rule page 600 includes a details or overview section 604, a rule criteria section 620, and a web form template section 640. To render or generate the rule page 600 on the client computing device 112, the provider computing system 104 may provide the specific rule and associated data to the client computing device 112.

The overview section 604 provides the user of the respective client computing device 112 with an interface to view and set an overview or general details of the rule of the rule page 600. As shown, the overview section 604 includes a name field 606, a follow-up type field 608, a number of days between attempts field 610, a total number of attempts to make field 612, and a rank or order field 614. The name field 606 may be similar or the same as the name field 506 of the rule management page 500. Likewise, the follow-up type field 608 may be similar or the same as the follow-up type field 508 of the rule management page 500. Similarly, the number of days between attempts field 610 and the total number of attempts to make field 612 may be similar to or the same as the number of days between attempts field 510 and the total number of attempts to make field 512 of the rule management page 500.

The rank or order field 614 may be a field through which the user of the respective client computing device 112 can review, edit, and/or initially set the rank or order of the rule associated with the rule page 600 which may then be sent by the respective client computing device 112 to the provider computing system 104 for storage (e.g., in the rule repository 132).

The rule criteria section or listing 620 provides the user an interface to initially set and manage the rule criteria of the rule of the rule page 600. As shown, the rule criteria section 620 includes one or more rule criteria representations 622 and a create button 634. The create button 634 is a selectable button that, when selected, causes the client computing device 112 to generate and provide a request to the provider computing system 104 to generate a new rule criteria of the rule. The rule criteria may be represented by a new rule criteria representation 622 in the rule criteria section 620. In some embodiments, in response to selecting the create button 634, a popup page or section (not shown) may be generated and displayed on the rule page 600. The popup page may receive rule criteria fields including a case object name, a field name, a field value, and the like. The client computing device 112 may then generate and provide a request to the provider computing system 104 to generate the rule criteria including the rule criteria data or fields described above.

Each rule criteria representation 622 may represent a specific rule criteria of the rule of the rule page 600. In this regard, the rule criteria representation 622 may include rule criteria data or fields of the rule criteria. As shown, each rule criteria representation 622 includes a case object name field 626, a data field name field 628, and a value field 630. The case object name field 626 and the data field name field 628 may each be utilized, by the provider computing system 104 to locate or navigate to the piece or field of case data of the case dataset, whereas the value field 630 may be the value that is utilized, by the provider computing system 104, to determine if the rule is met or validated. For example, referring to method 400, at step 412, the provider computing system 104 may select the data object of the case dataset identified by the case object name field 626. Then, the provider computing system 104 may select the piece or field of case data (of the selected data object) identified by the data field name field 628. Next, the provider computing system 104 may determine if the rule is met by determining if the selected piece of case data is the same as the value of the value field 630. If the pieces or fields of data are the same, the provider computing system 104 may proceed to step 416. If the pieces of fields of data are different, the provider computing system 104 may proceed back to step 412.

In some embodiments, if the rule criteria section 620 includes multiple rule criteria representations 622, each rule criteria must be met matched for the rule to be considered met. For instance, if the rule criteria section 622 includes a first rule criteria representation 622 (e.g., object name: “case_version_v”, field name: “seriousness_v”, and “value “serious_results_in_death_v”) and a second rule criteria representation 624 (e.g., object name: “case_product_v”, field name: “product_name_v”, and “value “drug_x_v”), both rule criteria must be met or satisfied for the rule to be met or satisfied. In other embodiments, if the rule criteria section 620 includes multiple rule criteria representations 622, only a single rule criteria must be met matched for the rule to be considered met.

The case object name field 626 may be a field through which the user of the respective client computing device 112 can review, edit, and/or initially set the name or identifier of the case data object a which is to be used to validate or meet the case criteria, which may then be sent by the respective client computing device 112 to the provider computing system 104 for storage (e.g., in the rule repository 132). For instance, as shown, the case object name field 626 is set to the “case_version_v” data object (i.e., the case version or general case data object). In another example, the case object name field may 626 may be set to the “case_product_v” data object (i.e., the medical product of the case). In this regard, the case object name field 626 may identify the case data object of the case dataset which is to be used to determine if the rule is validated or met.

Similarly, the data field name field 628 may be a field through which the user of the respective client computing device 112 can review, edit, and/or initially set the name or identifier of the data field of the case data object which is to be used to validate or meet the case criteria, which may then be sent by the respective client computing device 112 to the provider computing system 104 for storage (e.g., in the rule repository 132). For instance, as shown, the data field name field 628 is set to the “report_type_v” data field (i.e., the report type field). In another example, the data field name field 628 may may be set to the “expectedness_v” data field (i.e., the expectedness field). In this regard, the data field name field 628 may identify the piece of the case data object which is to be used to determine if the rule is validated or met.

The value field 630 may be a field through which the user of the respective client computing device 112 can review, edit, and/or initially set the value or the content with which piece of case data may have to be considered to having validated or met the rule, which may then be sent by the respective client computing device 112 to the provider computing system 104 for storage (e.g., in the rule repository 132).

The web form template section 640 provides the user an interface to initially set and manage the associated or digitally linked web forms templates of the rule of the rule page 600. As shown, the web form template section 640 includes one or more web form template representations 622 and an add button 660. The add button 660 is a selectable button that, when selected, causes the client computing device 112 to generate and provide a request to the provider computing system 104 to add a new associated web form template to the rule of the rule page 600. The web form template may be represented by a new web form template representation 642 in the web form template section 640. In some embodiments, in response to selecting the add button 660, a popup page or section (not shown) may be generated and displayed on the rule page 600. The popup page may include a listing of stored web form templates (e.g., of the web form repository 136). The client computing device 112 may then generate and provide a request to the provider computing system 104 to associate or link the selected web form template to the rule.

Each web form template representation 642 may represent a web form template associated with the rule of the rule page 600. In this regard, each web form template representation 642 may include web form template data or fields of the web form template. As shown, each web form template representation 642 includes a name field 644, an ad-hoc question preference field 646, and an ad-hoc section preference field 648. In some embodiments, each web form template representation 642 further includes a destination address field (not shown) and one or more delivery agent fields (not shown).

The name field 644 may be a field through which the user of the respective client computing device 112 can review, edit, and/or initially set the name of the web form template associated with the web form template representation 642 which may then be sent by the respective client computing device 112 to the provider computing system 104 for storage (e.g., in the rule repository 132). Further, the name field 644 may be a selectable button or link that, when selected, causes the client computing device 112 to navigate to a web form template page (not shown) for the web form template of the web form template representation 642.

The ad-hoc question preference field 646 and the ad-hoc section preference field 648 are each a field through which the user of the respective client computing device 112 can review, edit, and/or initially set ad-hoc question preference and the ad-hoc section preference, respectfully, of the web form template associated with the web form template representation 642 which may then be sent by the respective client computing device 112 to the provider computing system 104 for storage (e.g., in the rule repository 132).

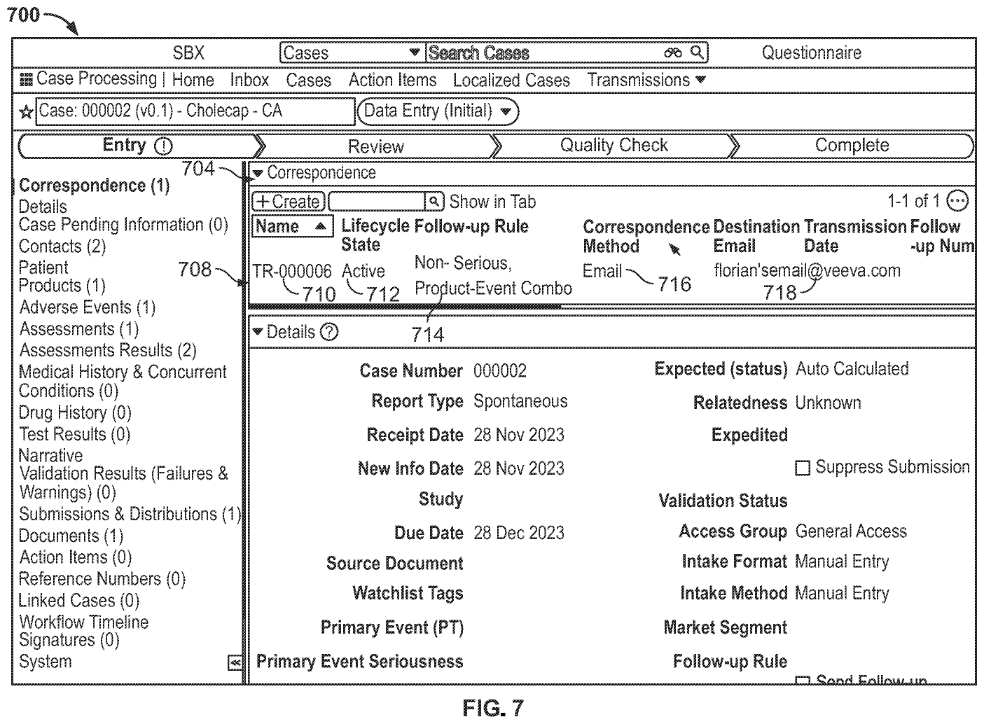

Referring now to FIG. 7, a case page 700 which can be displayed on a display the I/O circuit 180 of the client computing devices 112, is shown. In general, the case page 700 provides the user an interface to modify, manage, and process a specific case of the customer. As shown, the case page 700 includes a correspondence section 704. To render or generate the case page 700 on the client computing device 112, the provider computing system 104 may provide the case dataset and the case data of the case dataset to the client computing device 112. Further, as shown proximate the top of the case page 700, the case may process through and include multiple stages (e.g., “Entry,” “Review,” “Quality Check,” “Complete,” etc.). In some embodiments, in response to the state of the case entering a specific stage (e.g., in response to the “case_state_v” field of the case dataset being changed to a specific value (e.g., “Complete_v”), the provider computing system 104 may select the case dataset and perform the method 400, as described herein.

The correspondence section 704 provides the user of the respective client computing device 112 with an interface to view and manage digital communications or outputs of the provider computing system associated with the case of the case page 700. As shown, the correspondence section 704 includes one or more correspondence representations 708, which each represent a single correspondence or digital communication of the provider computing system 104. In this regard, each correspondence representation includes a name field 710, a lifecycle state field 712, a rule field 714, a correspondence method field 716, and a destination address field 718.

The name field 710 may be a field through which the user of the respective client computing device 112 can review, edit, and/or initially set the name of the correspondence associated with the correspondence representation 708 which may then be sent by the respective client computing device 112 to the provider computing system 104 for storage (e.g., in the rule repository 132). Further, the name field 710 may be a selectable button or link that, when selected, causes the client computing device 112 to navigate to a correspondence page 800 for the correspondence of the correspondence representation 708.

Similarly, the state field 712 may be a field through which the user of the respective client computing device 112 can review the state (e.g., active, completed, sent, response received, etc.) of the correspondence associated with the correspondence representation 708. Likewise, the rule field 714 may be a field through which the user of the respective client computing device 112 can review the rule (e.g., active, completed, sent, response received, etc.) which resulted in the generation of the correspondence associated with the correspondence representation 708.

The correspondence method field 716 may be a field through which the user of the respective client computing device 112 can initially, set, and/or review the communication protocol or methodology for providing the correspondence to the destination (e.g., active, completed, sent, response received, etc.) of the correspondence associated with the correspondence representation 708, which may then be sent to the provider computing system 104 by the respective client computing device 112. Similarly, the destination address field 718 may be a field through which the user of the respective client computing device 112 can initially, set, and/or review the destination address to which the correspondence is to be provided, which may then be sent to the provider computing system 104 by the respective client computing device 112.

Referring now to FIGS. 8A-8B, a correspondence page 800 which can be displayed on a display the I/O circuit 180 of the client computing devices 112, is shown. In general, the correspondence page 800 provides the user an interface to modify, manage, submit, and generate a follow-up or new version of a case dataset based on the correspondence. As shown, the correspondence page 800 includes a questionnaire or web form section 804, a response(s) section 824, a transmit correspondence button 840, and an options button 844. To render or generate the correspondence page 800 on the client computing device 112, the provider computing system 104 may provide the digital document and/or the generated correspondence (also referred to as a delivery agent) to the client computing device 112. As described herein, each correspondence may include multiple states or stages, as shown proximate the top of FIGS. 8A-8B (e.g., New, Sent, Complete, etc.). In this regard, FIG. 8A may show a “new” or newly generated correspondence; whereas FIG. 8B may show a “complete” or correspondence in which a response has been received.

The web form section 804 provides the user of the respective client computing device 112 with an interface to view and manage web forms or questionnaires of the provider computing system 104 which are to be included or linked to in the correspondence. As shown, the web form section 804 includes one or more web form representations 808 and a create button 820. The create button 820 is a selectable button that, when selected, causes the client computing device 112 to generate and provide a request to the provider computing system 104 to generate a new web form, which is to be included (or linked to) in the correspondence. The web form may be represented by a new web form representation 804. In some embodiments, in response to selecting the create button 820, a popup page or section (not shown) may be generated and displayed on the correspondence page 800. The popup page may display and receive web form data or a web form template. The client computing device 112 may then generate and provide a request to the provider computing system 104 to generate a web form based on the web form template.

Each web form representation 804 may represent a web form of the provider computing system 104 which is to be included or linked to (e.g., have a public access link) in the correspondence of the correspondence page 800. In this regard, each web form representation 804 may include a name field 810, a lifecycle state field 812, an aggregate checklist field 814, and other web form fields or data described herein (e.g., welcome email subject, welcome email text, etc.).

The name field 810 may be a field through which the user of the respective client computing device 112 can review, edit, and/or initially set the name of the web form associated with the web form representation 804 which may then be sent by the respective client computing device 112 to the provider computing system 104 for storage. Further, the name field 810 may be a selectable button or link that, when selected, causes the client computing device 112 to navigate to a web form page 100, as will be described further herein.

Likewise, the lifecycle state field 812 may be a field through which the user of the respective client computing device 112 can review the state of the web form associated with the web form representation 804. Similarly, the aggregate checklist field 814 may be a field through which the user of the respective client computing device 112 can review the aggregate checklist preference of the web form associated with the web form representation 804.

The transmit or transmit correspondence button 840 is a selectable button that, when selected, causes the client computing device 112 to generate and provide a request to the provider computing system 104 to output the correspondence (also referred to as the delivery agent). The provider computing system 104 may receive the request and output the correspondence to the destination address, as described with regard to step 432 of the method 400. In some embodiments, the rule may include a transmission preference which indicates whether the provider computing system 104 is to automatically transmit the correspondence including the public access link, or to transmit the correspondence including the public access link, in response to receiving the request to do so.

Once the provider computing system 104 has received a response to the correspondence (e.g., a selection of the public access link and editing of the web form to add follow-up case data), the provider computing system 104 may provide the follow-up case data to the respective client computing device 112 for display in the responses section 824. In this regard, the responses section 824 may provide the user of the respective client computing device 112 with an interface to view and manage the responses or follow-up case data received, in response to a selection of the public access link. The responses section 824 includes one or more response representations 830.

Each response representation 830 may represent a piece of follow-up case data or a response to a question of the web form. For instance, the correspondence of the correspondence including six questions (as indicated by the six response representations 830); and a second public access link to a second digital document including four questions (as indicated by the four response representations 830). As shown, each response representation 830 includes a name field 832, a web form field 834, a question text field 836, and a response text field 838. In some embodiments, the response representation 830 may include a response date field (not shown).

The name field 832 is a selectable field that, when selected, navigates the client computing device 112 to the web form page 1000 and centers the web form page 100 on the question and response of the response representation 830. Likewise, the web form field 834 is a selectable field that, when selected, navigates the client computing device 112 to the web form page 1000 of the web form of the web form field 834.

The question text field 836 is a field that displays the question of the web form, which resulted in the response of the response text field 838. In this regard, the question text field 836 includes the question asked of the user, whereas the response text field 838 includes the response answered or provided by the user.

The options button 844 is a selectable button that, when selected, causes the client computing device 112 to display one or more options including the create follow-up case option 850. The create follow-up case option 850 is a selectable option that, when selected, causes the client computing device 112 to generate and provide a request to generate a follow-up or versioned case dataset based on the case dataset and the responses or follow-up case data of the responses section 824. For instance, in response to receiving the request, the provider computing system 104 may version or update the case dataset by generating a versioned case dataset (e.g., from version 1.0 to 2.0). The versioned case dataset may include the case data of the case dataset and the follow-up case data received via the public access link. In some embodiments, the versioned or follow-up case dataset may be submitted to one or more of the partner computing systems 108, as described herein.

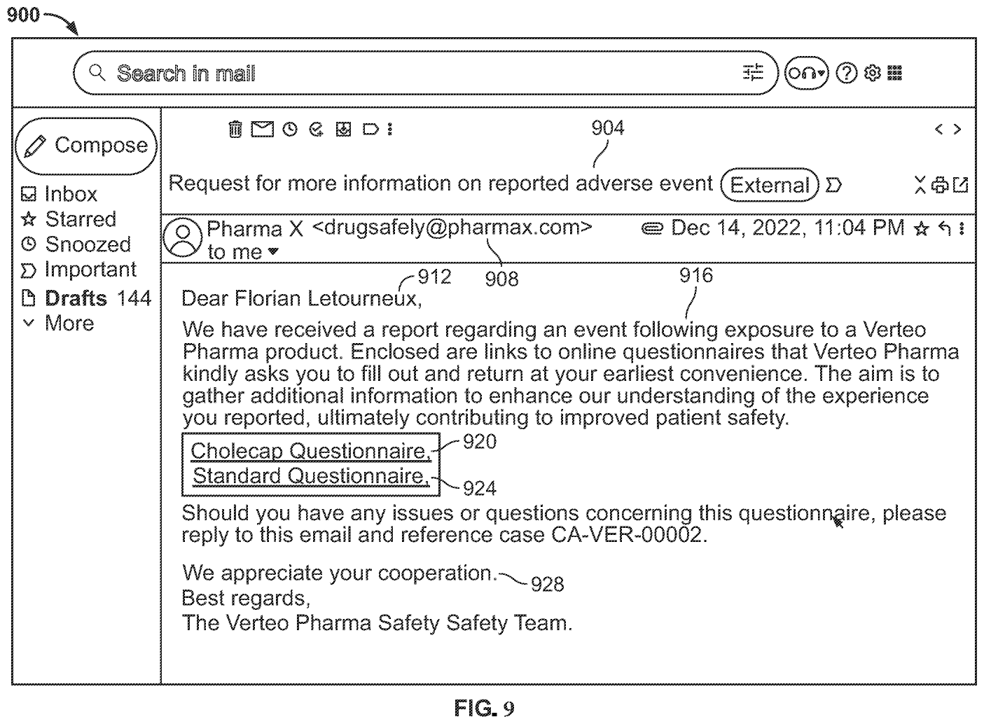

Referring now to FIG. 9, a correspondence or delivery agent 900 which can be displayed on a display the I/O circuit 180 of the client computing device 112, is shown. In general, the correspondence 900 includes and provides for the delivery of the public access link(s). In the example shown in FIG. 9, the correspondence 900 is an email generated and output by the provider computing system 104. In other embodiments, the correspondence or delivery agent may include a file share request or notification including the public access link(s), a text or digital message including the public access link(s), an instant message including the public access link(s), and the like. As shown, the correspondence 900 includes a subject or header 904; a correspondence address 908; multiple text sections including an introduction or greeting text section 912, a body text section 916, and a signature or ending text section 928; and a first public access link 920, and a second public access link 924. In some embodiments, as described herein, the provider computing system 104 may receive the multiple text sections in a first language (e.g., from the client computing device 112) and translate the text sections and the subject or header 904 to a second language based on the language of the reporter of the case data. For instance, the provider computing system 104 may receive the text sections and the subject 904 in English from one of the client computing devices 112. Then, in response to determining the reporter's language is Spanish, the provider computing system 104 may translate each to Spanish. The provider computing system 104 may then generate the correspondence to include the text sections and subject 904 in Spanish, as well as the public access links 920 and 924.

Referring now to FIGS. 10A-10B, the web form page 1000 which can be displayed on a display the I/O circuit 180 of the client computing device 112, is shown. In general, the web form page 1000 provides the user an interface to modify, manage, and submit the web form generated by the provider computing system 104. While not shown, the web form and the web form page 1000 includes multiple question or text sections such as the instructions section (not shown), the patient information section 1002, the adverse event section (not shown), the medical product section (not shown), and a review section 1024. Each question or inquiry section includes multiple questions including text data (e.g., a text label “Patient Initials”, etc.) and a field (e.g., a text field, a drop-down box including multiple options, etc.) for providing a response to the question. In some embodiments, the text field may be prepopulated with case data, such as shown in the patient initials question 1004. As shown, the patient information section 1002 includes multiple questions including text data such as a patient initials question 1004, a MRN question 1006, a date of birth question 1008, and a pregnancy question 1010. Further, the web form page 1000 includes a cancel button 1012, a back button 1014, and a next button 1016 for navigating the sections of the web form. The review section 1024 provides an interface to review the responses or follow-up case data provided via the web form 1000 and further includes a complete button 1040.

It should be noted that step 440 of the method 400 may include the outputting and display of each of the text sections of the web form (each including multiple questions including text data) for display on the user interface, as shown in FIGS. 10A-10B. For instance, the provider computing system 104 may provide the web form including the multiple text sections for display on the user interface of a respective client computing device 112. Then, in response to the user of the client computing device 112 providing text answers (e.g., follow-up case data), and selecting the complete button 1040, the client computing device 112 may provide the updated web form including the follow-up case data to the provider computing system 104, as described with regard to step 444 of the method 400.

Additionally, as described herein, the text data of the web form page 1000 (e.g., the questions (e.g., “Patient Initials”, “MRN”, “Date of Birth” “Pregnant”, etc.), may be generated and displayed in a specific language of the reporter (e.g., based on the reporter data of the case dataset, as described herein) for each section. For instance, in response to the reporter's primary language being English, the web form page 1000 may include the text data in English, as shown. In comparison, in response to the reporter's primary language being Spanish, the web form page 1000 may include the text data in Spanish.

The embodiments described herein have been described with reference to the drawings. The drawings illustrate certain details of specific embodiments that implement the systems, methods, and programs described herein. However, describing the embodiments with drawings should not be construed as imposing on the disclosure any limitations that may be present in the drawings.

It should be understood that no claim element herein is to be construed under the provision of 35 U.S.C §112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexors, registers, capacitors, inductors, diodes, wiring, and so on.

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other embodiments, two or more processors may be coupled via a bus to enable independent, parallel, pipelined, or multi-threaded instruction execution. Each processor may be implemented as one or more general purpose processors, application specific integrated circuits (ASICs), field programmable gate arrays (FPGAs), digital signal processors (DSPs), or other suitable electronic data processing components structured to execute instructions provided by the memory. The one or more processors may take the form of a single core processor, a multi-core processor (e.g., dual core, quad core, etc.), microprocessor, etc. In some embodiments, the one or more processors may be external to the apparatus. For example, the one or more processors may be a remote processor (e.g., a cloud-based processor). Alternatively or additionally, the one or more processors may be internal and/or local to the apparatus. In this regard, a circuit or components thereof may be disposed locally (e.g., as part of a local server, a local computing system) or remotely (e.g., as part of a remote server such as a cloud-based server). To that end, a “circuit” as described herein may include components that are distributed across one or more locations. Further, each of the circuits described herein may be distributed across one or more locations (e.g., each as part of one or more remote servers).

An example system for implementing the overall system or portions of the embodiments might include a general-purpose computing device in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile storage media may take the form of ROM, flash memory (e.g., flash memory such as NAND, 3D NAND, NOR, 3D NOR), EEPROM, MRAM, magnetic storage, hard disks, optical disks, etc. Combinations of the above are also included within the scope of machine-readable media. In this regard, machine-executable instructions comprise, for example, instructions and data which cause a general-purpose computer, special purpose computer, or special purpose processing machine to perform a certain function or group of functions. Each respective memory device may be operable to maintain or otherwise store data relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, a joystick, or other input devices performing a similar function. Comparatively, the term “output device,” as described herein, may include any type of output device including, but not limited to, a computer monitor, printer, facsimile machine, or other output devices performing a similar function.

It should be noted that the term “field,” as described herein may include any form of an input field through which the user interfaces shown and described may receive input from a user of a computing device. For instance, the term “field” may include a text field, a drop-down box and selectable options, a list box, a lookup box, a search bar, an icon, one or more checkboxes, one or more radio buttons, a button, a toggle, a date field, a slider, and the like. Further, each “field” may include and/or receive data that may be associated with a data object as described herein.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps, and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principles of the disclosure and its practical application to enable one skilled in the art to utilize the various embodiments and with various modifications as are suited to the particular use contemplated. Other substitutions, modifications, changes, and omissions may be made in the design, operating conditions and embodiment of the embodiments without departing from the scope of the present disclosure as expressed in the appended claim.

What is claimed is:

1. A method for generating a web form comprising:
receiving, by a provider computing system, a source file;
determining, by the provider computing system, case data based on the source file;
generating, by the provider computing system, a case dataset including the case data;
selecting, by the provider computing system, a rule including a rule criteria and a destination address from a first repository of the provider computing system;
determining, by the provider computing system, the case data of the case dataset fulfills the rule criteria;
selecting, by the provider computing system, a web form template from a second repository of the provider computing system;
generating, by the provider computing system, the web form based on the web form template and the case dataset,
wherein the web form includes at least a portion of the case data of the case dataset;
generating, by the provider computing system, a link associated with the web form;
outputting, by the provider computing system, the link to the destination address of the rule;
receiving, by the provider computing system, a request to access the web form;
outputting, by the provider computing system, the web form based on the request; and
receiving, by the provider computing system, follow-up case data.

2. The method of claim 1, further comprising:
outputting, by the provider computing system, the case dataset including the case data as an E2B XML file.

3. The method of claim 2, wherein the rule includes a rule trigger, and wherein the method further comprising:
modifying, by the provider computing system and in response to outputting the case dataset, a state of the case dataset from a first stage to a second stage; and
selecting, by the provider computing system and in response to the rule trigger of the rule being met based on the state of the case dataset being the second stage, the rule from the first repository of the provider computing system.

4. The method of claim 2, further comprising:
modifying, by the provider computing system, the case dataset to include the follow-up case data; and
outputting, by the provider computing system and after outputting the case dataset, the modified case dataset including the follow-up case data as an E2B XML file.

5. The method of claim 4, wherein the case dataset includes a version of the case dataset, and wherein modifying the case dataset includes:
generating, by the provider computing system, a new version of the case dataset; and
modifying, by the provider computing system, the case dataset to include the follow-up case data and the new version.

6. The method of claim 4, further comprising:
receiving, by the provider computing system, one or more mapping preferences; and
modifying, by the provider computing system, the case dataset to include the follow-up case data based on the one or more mapping preferences.

7. The method of claim 1, wherein the case data includes reporter data, wherein the web form template includes first text data in a first language and second text data in a second language, and wherein the method further comprises:
determining, by the provider computing system, a language of the reporter based on the reporter data; and
generating, by the provider computing system and in response to the language of the reporter being the first language, the web form including the first text data in the first language based on the web form template.

8. The method of claim 1, wherein the case data includes reporter data, wherein the web form template includes text data in a first language, and wherein the method further comprises:
determining, by the provider computing system, a language of the reporter based on the reporter data;
translating, by the provider computing system and in response to the language of the reporter being a second language, the text data of the web form template from the first language to the second language; and
generating, by the provider computing system, the web form including the translated text data.

9. The method of claim 1, wherein the link is a public access link, and wherein the method further comprises:
generating, by the provider computing system, a token;
generating, by the provider computing system, the public access link including a uniform resource locator (URL), wherein the URL includes the token;
generating, by the provider computing system, a correspondence including the public access link;
outputting, by the provider computing system, the correspondence including the public access link to the destination address;
receiving, by the provider computing system, a request to access the web form including the token from a client computing device;
validating, by the provider computing system, the client computing device based on the token; and
outputting, by the provider computing system and in response to validating the client computing device, the web form to the validated client computing device.

10. The method of claim 1, wherein the rule is a first rule, wherein the rule criteria is a first rule criteria, and wherein the method further comprises:
selecting, by the provider computing system, a second rule including a second rule criteria from the first repository of the provider computing system;
determining, by the provider computing system, the case data of the case dataset does not fulfill the second rule criteria; and
selecting, by the provider computing system and in response to determining the case data of the case dataset does not fulfill the second rule criteria, the first rule including the first rule criteria and the destination address from the first repository of the provider computing system.

11. The method of claim 1, wherein the web form includes one or more text sections, wherein the web form is output to a client computing device for display on a user interface including the one or more text sections, and wherein the follow-up case data is received from the client computing device via the one or more text sections of the user interface.

12. A method for generating a web form comprising:
selecting, by a provider computing system, a case dataset including case data from a first repository of the provider computing system;
selecting, by the provider computing system, a rule including a rule criteria from a second repository of the provider computing system;
determining, by the provider computing system, the case data of the case dataset fulfills the rule criteria;
selecting, by the provider computing system, a web form template from a third repository of the provider computing system,
wherein the web form template identifies a first section to include in the web form;
receiving, by the provider computing system, a request identifying a second section to include in the web form;
generating, by the provider computing system, the web form including the first section and the second section based on the web form template and the request;
generating, by the provider computing system, a link associated with the web form;
determining, by the provider computing system, a destination address;
outputting, by the provider computing system, the link to the destination address;
receiving, by the provider computing system, follow-up case data;
modifying, by the provider computing system, the case dataset to include the follow-up case data; and
storing, by the provider computing system, the modified case dataset in the first repository.

13. The method of claim 12, wherein the case data includes reporter data, wherein the first section of the web form template and the second section of the request each include text data in a first language, and wherein the method further comprises:
determining, by the provider computing system, a language of the reporter based on the reporter data;
translating, by the provider computing system and in response to the language of the reporter being a second language, the text data of the first section and the second section from the first language to the second language; and
generating, by the provider computing system, the web form including the first section including the text data of the first section in the second language and the second section including the text data of the second section in the second language.

14. The method of claim 12, further comprising:
receiving, by a provider computing system, a source file;
determining, by the provider computing system, the case data based on the source file;
generating, by the provider computing system, the case dataset including the case data; and
storing, by the provider computing system, the case dataset in the first repository.

15. The method of claim 12, wherein the case data includes reporter data including a reporter address, and wherein the destination address is determined based on the reporter address.

16. The method of claim 12, wherein the link is a public access link, and wherein the method further comprises:
generating, by the provider computing system, a token;
generating, by the provider computing system, the public access link including a uniform resource locator (URL), wherein the URL includes the token;
generating, by the provider computing system, a correspondence including the public access link;
outputting, by the provider computing system, the correspondence including the public access link to the destination address;
receiving, by the provider computing system, a request to access the web form including the token from a client computing device;
validating, by the provider computing system, the client computing device based on the token; and
outputting, by the provider computing system and in response to validating the client computing device, the web form to the validated client computing device.

17. The method of claim 12, wherein the case data includes a patient's initials, and wherein the first section of the web form includes the patient's initials of the case data.

18. The method of claim 12, wherein the rule is a first rule, wherein the rule criteria is a first rule criteria, and wherein the method further comprises:
selecting, by the provider computing system, a second rule including a second rule criteria from the second repository of the provider computing system;
determining, by the provider computing system, the case data of the case dataset does not fulfill the second rule criteria; and
selecting, by the provider computing system and in response to determining the case data of the case dataset does not fulfill the second rule criteria, the first rule including the first rule criteria and the destination address from the second repository of the provider computing system.

19. A method for generating a web form comprising:
selecting, by a provider computing system, a case dataset including case data from a first repository of the provider computing system,
wherein the case data includes reporter data;
selecting, by the provider computing system, a rule including a rule criteria from a second repository of the provider computing system;
determining, by the provider computing system, the case data of the case dataset fulfills the at least one rule criteria;
selecting, by the provider computing system, a first web form template including text data in a first language from a third repository of the provider computing system;
selecting, by the provider computing system, a second web form template including text data in a second language from the third repository of the provider computing system;
determining, by the provider computing system, a language of the reporter based on the reporter data;
selecting, by the provider computing system and in response to the language of the reporter being the first language, the first web form template;
generating, by the provider computing system, the web form based on the selected first web form template;
generating, by the provider computing system, a link associated with the web form;
determining, by the provider computing system, a destination address;
outputting, by the provider computing system, the link to the destination address;
receiving, by the provider computing system, follow-up case data;
modifying, by the provider computing system, the case dataset to include the follow-up case data; and
storing, by the provider computing system, the modified case dataset in the first repository.

20. The method of claim 19, wherein the link is a public access link, and wherein the method further comprises:
generating, by the provider computing system, a token;
generating, by the provider computing system, the public access link including a uniform resource locator (URL), wherein the URL includes the token;
generating, by the provider computing system, a correspondence including the public access link;
outputting, by the provider computing system, the correspondence including the public access link to the destination address;
receiving, by the provider computing system, a request to access the web form including the token from a client computing device;
validating, by the provider computing system, the client computing device based on the token; and
outputting, by the provider computing system and in response to validating the client computing device, the web form to the validated client computing device.
